(19) United States
(12) Patent Application Publication
(10) Pub. No.: US 2025/0307660 A1
(43) Pub. Date: Oct. 2, 2025

(54) CAUSAL INFERENCING IN DISTRIBUTED COMPUTING ENVIRONMENTS USING TRAINED DOUBLE MACHINE LEARNING AND TRAINED CLASSIFIERS

(71) Applicant: The Toronto-Dominion Bank, Toronto (CA)

(72) Inventors: Sheldon Lu-Ming TUNG, Markham (CA); Sneha Desai, Toronto (CA); Jean-Christophe Bouëtté, Montreal (CA); Anna Keshabyan-Prasad, Maple Ridge (CA); Ozair Islam, Mississauga (CA)

(21) Appl. No.: 19/090,162

(22) Filed: Mar. 25, 2025

Related U.S. Application Data
(60) Provisional application No. 63/570,733, filed on Mar. 27, 2024.

(51) Int. Cl. G06N 5/01; G06F 18/241

(52) U.S. Cl. CPC G06N 5/01; G06F 18/241

(57) ABSTRACT

The disclosed embodiments include computer-implemented apparatuses and processes that perform causal inferencing in distributed computing environments using trained double machine learning and trained classifiers. For example, an apparatus may receive, from a device, a request that includes identifier associated with the device and exception data that includes a requested modification to a value of a parameter of a data exchange. The apparatus may also obtain labelling data based on an application of a trained classifier to a first input dataset that includes a value of an elasticity parameter associated with the request, may generate elements of decision data associated with the requested modification based on the labelling data and on the exception data, and may transmit, to the device, a response to the request that includes the elements of decision data.

### CROSS-REFERENCE TO RELATED APPLICATION

This application claims the benefit of priority to U.S. Provisional Application No. 63/570,733, filed on Mar. 27, 2024, and to U.S. Provisional Application No. 63/570,908, filed on Mar. 28, 2024. The entire disclosure of each of these provisional applications is incorporated expressly herein by reference to its entirety.

### TECHNICAL FIELD

The disclosed embodiments relate to computer-implemented systems and processes that perform causal inferencing in distributed computing environments using trained double machine learning and trained classifiers.

### BACKGROUND

Many organizations offer products and services to their customers subject to an acceptance of an offered parameter value and subject to a successful processing, and subsequent approval, of a corresponding application and supporting documentation. In response to a request for a particular products or services from a customer, these organizations often rely on a standardized parameter values that account for seasonality or internal demand within the organization, but that often lack any personalization that reflects the customer's relationship with, or usage of, the products or services.

### SUMMARY

In some examples, an apparatus includes a memory storing instructions, a communications interface, and at least one processor coupled to the memory and the communications interface. The at least one processor is configured to execute the instructions to receive a request from a device via the communications interface. The request includes an identifier associated with the device and exception data, and the exception data includes a requested modification to a value of a parameter of a data exchange. The at least one processor is configured to execute the instructions to obtain labelling data based on an application of a trained classifier to a first input dataset that includes a value of an elasticity parameter associated with the request, and generate elements of decision data associated with the requested modification based on the labelling data and on the exception data. The at least one processor is configured to execute the instructions to transmit, to the device via the communications interface, a response to the request that includes the elements of decision data.

In other examples, a computer-implemented method includes receiving a request from a device using at least one processor. The request includes an identifier associated with the device and exception data, and the exception data includes a requested modification to a value of a parameter of a data exchange. The computer-implemented method also includes obtaining, using the at least one processor, labelling data based on an application of a trained classifier to a first input dataset that includes a value of an elasticity parameter associated with the request, and generating, using the at least one processor, elements of decision data associated with the requested modification based on the labelling data and on the exception data. The computer-implemented method also includes transmitting, to the device using the at least one processor, a response to the request that includes the elements of decision data.

Further, in some examples, a tangible, non-transitory computer-readable medium storing instructions that, when executed by at least one processor, cause the at least one processor to perform a method that includes receiving a request from a device. The request includes an identifier associated with the device and exception data, and the exception data includes a requested modification to a value of a parameter of a data exchange. The method also includes obtaining labelling data based on an application of a trained classifier to a first input dataset that includes a value of an elasticity parameter associated with the request, and generating elements of decision data associated with the requested modification based on the labelling data and on the exception data. The method also includes transmitting, to the device, a response to the request that includes the elements of decision data.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1, 2A, and 2B are block diagrams illustrating portions of an exemplary computing environment, in accordance with some examples.

FIGS. 2C and 2D are diagrams of exemplary timelines for adaptively training a machine-learning or artificial intelligence process, in accordance with some examples.

FIGS. 2E and 3A-3C are block diagrams illustrating portions of an exemplary computing environment, in accordance with some examples.

FIG. 4 is a flowchart of an exemplary process for adaptively training a machine learning or artificial intelligence process, in accordance with some exemplary embodiments.

FIG. 5 is a flowchart of an exemplary process for training adaptively a double machine-learning process to estimate values of treatment elasticity within a distributed computing environment, in accordance with some examples.

FIG. 6 is an exemplary process for estimating values of treatment elasticity using trained double machine-learning process and labelling the determined values of treatment elasticity using trained, classifiers, according to some examples.

FIG. 7 is a flowchart of an exemplary process for adjudicating exception requests using trained double machine-learning processes, in accordance with some examples.

Like reference numbers and designations in the various drawings indicate like elements.

### DETAILED DESCRIPTION

Many organizations offer products and services to their customers subject to an acceptance of an offered rate and subject to a successful processing, and subsequent approval, of a corresponding application and supporting documentation. In response to a request for a product from a customer, these organizations often rely on standardized rates that may account for seasonality or internal demand within the organization, but that often lack any personalization that reflects the customer's relationship with, or usage of, the product or the customer's sensitivity to changes in the offered rate. For instance, a usage or consumption of a particular product by certain customers of an organization may exhibit little sensitivity to changes in the offered rates, while for other customers, a usage of the product may depend strongly on, and exhibit a high sensitivity toward, any changes in the offered rates.

By way of example, the organization may operate a distributed computing cluster, and the organization may meter access to the computational resources within segments of the distributed computing cluster (e.g., segments with different processing capabilities, different amount of available memory, etc.) in accordance with access rates that reflect costs associated with an operation of the distributed computing cluster and additionally, or alternatively, an expected demand within corresponding segments of the distributed computing cluster. In many instances, these access rates are fixed across large groups of customers of the organization and lack any personalization to the sensitivities of these customers to changes in the access rates. For example, due to increased operational costs (e.g., due to increased electrical costs, etc.), the organization may elect impose a fixed surcharge (e.g., a treatment) of three percent on the access fees for the distributed computing clusters, and the three-percent surcharge may be imposed uniformly across all customers of the organization.

In many instances, the uniform imposition of the fixed treatment across all customers of the organization, without any personalization to reflect initial rate sensitivities of these customers, may result in an underutilization of the computational resources within the cluster. For example, for a customer characterized by a low sensitivity to the access rate, the imposition of the fixed treatment may result in a minimal change in that customer's usage of computational resources within the distributed computing cluster. In other examples, for a customer characterized by a relatively high sensitivity to access rates, the imposition of the fixed treatment may result in a substantial change in that customer's usage of computational resources within the distributed computing cluster, and when aggregated across multiple customers characterized by relatively high sensitivities to access rates, the imposition of the fixed, personalized surcharge may result in an underutilization of the computational resources of the distributed computing cluster.

Further, the imposition of the fixed surcharge across the customers of the organization may also cause customers of both low- and high-price sensitivities, to request exceptions to the imposed surcharge, such as, but no limited to, a waiver of the surcharge or a reduction in the magnitude of that surcharge. In many instances, computing systems operated by the organization often resolve these requests for exceptions programmatically based on an application of rules-based processes to the requested exception requests, e.g., to approve any request for an exception associated with a value that fails to exceed a threshold value, or to automatically grant an exception of a predetermined magnitude to any requesting customer. The reliance on ruled-based processing to adjudicate exception requests associated with corresponding customers, without any personalization to reflect the rate sensitivities of these requesting customers, may also result in an underutilization of the computational resources of the distributed computing cluster, as these rules-based processes reward may reward customers characterized by a low sensitivities to the access rate with exceptions to the imposed surcharge without resulting in any increased consumption of computational resources.

Today, organizations attempt to characterize the sensitivity of their customers to increases, or alternatively, decreases, in prices and rates associated with a provisioned product based on an implementation, by one or more computing systems, of predictive processes that assign discrete pricing or rate treatments to groups of customers, and that simulate a future utilization of the provisioned product by these different customer groups subjected to corresponding ones of the discrete pricing or rate treatments. While these predictive processes may provide insight on a sensitivity of the groups of customers across the assigned, discrete pricing or rate treatments, any resulting insight would be limited to the assigned, discrete pricing or rate treatments, and these predictive processes would be incapable of providing insights across a continuum of potential prices or rates. Furthermore, the application of these predictive processes across a sufficient number of discrete treatments to provide insights on rate sensitivity across the continuum would be computationally infeasible.

Further, many of these existing predictive processes rely on historical data that, while providing insight on the potential relationship between a customer's usage or consumption of a provisioned product and a per-unit rate associated with that usage or consumption, the results of these existing predictive processes are often rendered inaccurate due to noise within the historical data and additionally, or alternatively, by bias within the historical data. For example, the historical data characterizing a customer's usage or consumption of a provisioned product may include elements of data, e.g., outliers, that do not reflect the underlying relationship between the customer's usage or consumption of a provisioned product and the per-unit cost of that consumption, such as, but not limited to, external factors such as weather, holidays, etc. Further, in many instances, the historical data characterizing a customer's usage or consumption of a provisioned product may be influenced by elements of organizational or seasonal bias that enhances the customer's usage or consumption of a provisioned product or reduces the associated costs, such as, but not limited to incentives offered by the organization during certain temporal intervals.

One or more of the exemplary processes described herein may enable a computing system associated with the organization to train a double machine-learning process to predict, in real time and for a corresponding customer, a customer-specific value of a treatment elasticity associated with a product available for provisioning by the organization. As described herein, the customer-specific value of the treatment elasticity may characterize, for a customer, an expected change in that customer's interaction with a product available for provisioning by the organization in response to an incremental modification in a rate associated with the product (e.g., in response to a “treatment” applied to the associated rate). For example, the customer's interaction with the available product may be characterized by a “volume” of that product consumed, used, or held by the customer during one or more temporal intervals, and the incremental modification to the rate, e.g., the applied “treatment,” may represent a modification in a per-unit rate to access or use the product (e.g., measured in currency, etc.) or a modification in an interest rate associated with the product (e.g., measured in basis points, etc.).

The double machine-learning process may include (i) a first machine-learning or artificial-intelligence process (e.g., a “de-noising process”), which may be trained adaptively to predict, at the temporal prediction point, a customer-specific product volume consumed, used, or held at a temporal endpoint of a future temporal interval; (ii) a second machine-learning or artificial-intelligence process (e.g., a “de-biasing process”), which may be trained adaptively to predict, at the temporal prediction point, treatment offered by the organization for the consumption, use, or holding of the product volume at the temporal endpoint of a future temporal interval; and (iii) a linear-regression process (e.g., an elasticity process) which may be coupled to the output of the first and second machine-learning or artificial-intelligence processes, which may be trained adaptively to predict, at the temporal prediction point, an expected product volume that would result from a product-specific treatment offered by the organization for the product. In some instances, the application of the trained de-noising and de-biasing processes to input datasets derived from data characterizing historical interactions between the customer and the product may reduce, or eliminate, the level of noise and bias present within the input datasets, and the application of trained regression process to the predicted, customer-specific product volumes and treatments may establish a relationship between the predicted product volumes and the predicted treatments across a continuum of possible treatments (e.g., a continuum of possible rates and costs).

Further, one or more of the exemplary processes described herein may enable a computing system associated with the organization to train a classifier to label a customer of the organization as a low- or high-treatment-elasticity customer based on using corresponding training and validation datasets that include that customer-specific value of the treatment elasticity and feature values extracted from temporally distinct subsets of the preprocessed, consolidated, and aggregated data elements described herein. Through an implementation of these exemplary processes, one or more computing systems of the organization may apply the trained classifier to input datasets that include the customer-specific values of the treatment elasticity and the customer-specific feature values, and generate output data that labels the customers associated with each of the customer-specific input datasets as a low- or high-treatment-elasticity customers. In some instances, as described herein, the assigned labels may facilitate an adjudication of received requests to obtain product-specific exceptions to initially offered, per-unit rates or treatments using any of the exemplary adjudication processes described herein.

Certain of the exemplary processes described herein, which apply a trained double machine-learning process to input datasets and predict, in real time and across a continuum of rates and treatments, customer-specific values of a treatment elasticity associated with a product available for provisioning by the organization, which apply a trained classifier to customer-specific input datasets that include the customer-specific values of the treatment and generate output data that labels the customers associated with each of the customer-specific input datasets as a low- or high-treatment-elasticity customers in a computationally feasible manner, and that adjudicate requests for exception based on the labelled customers, may be implemented in addition to, or as an alternate to, existing predictive processes that require a computationally infeasible number of computational simulations to characterize rate sensitivity across the continuum of rate based on noisy and biased input data.

### A. Exemplary Computing Environments

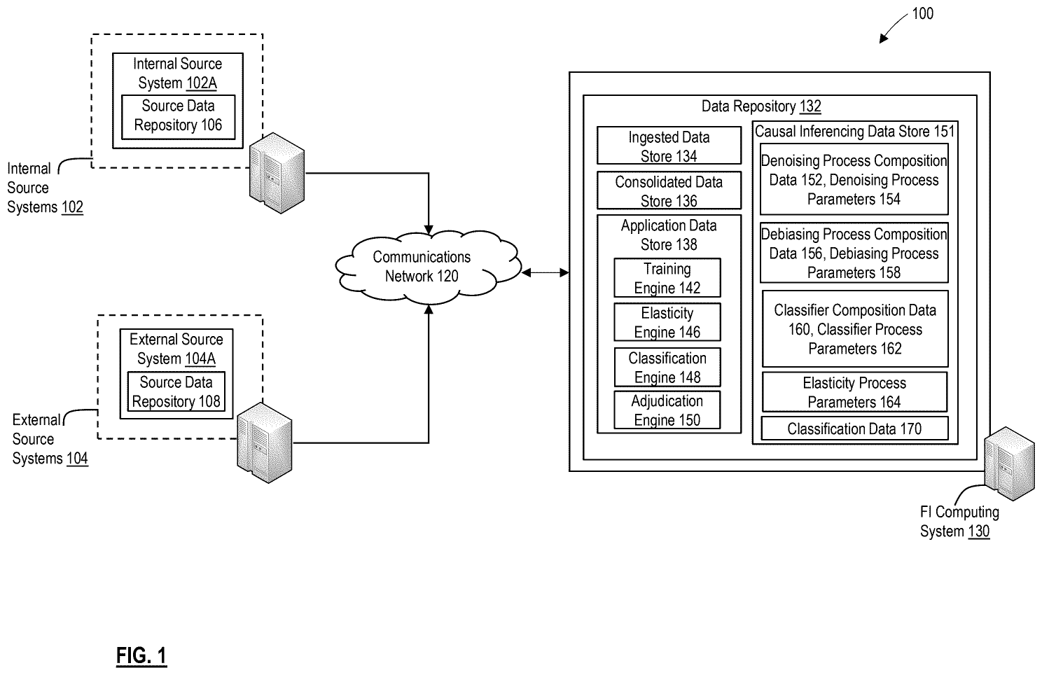

FIG. 1 illustrates components of an exemplary computing environment 100, in accordance with some exemplary embodiments. For example, as illustrated in FIG. 1, environment 100 may include one or more internal source systems 102, such as, but not limited to, source system 102A, one or more external source systems 104, such as, but not limited to, external source system 104A, and one or more computing systems associated with, or operated by, an organization, such as a computing system 130, In some instances, each of source systems 102 (including source systems 102A), external source systems 104 (including external source system 104A), and computing system 130, may be interconnected through one or more communications networks, such as communications network 120. Examples of communications network 120 include, but are not limited to, a wireless local area network (LAN), e.g., a Wi-Fi™ network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including source systems 102A), external source systems 104 (including external source system 104A), and computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Each of internal source systems 102 (including source systems 102A), external source systems 104 (including external source system 104A), and computing system 130 may also include a communications interface, such as one or more wireless transceivers, coupled to the one or more processors for accommodating wired or wireless internet communication with other computing systems and devices operating within environment 100.

Further, in some instances, internal source systems 102 (including source system 102A), external source systems 104 (including external source system 104A), and computing system 130 may each be incorporated into a respective, discrete computing system. In additional, or alternate, instances, one or more of internal source systems 102 (including source system 102A), external source systems 104 (including external source system 104A), and computing system 130 may correspond to a distributed computing system having a plurality of interconnected, computing components distributed across an appropriate computing network, such as communications network 120 of FIG. 1. For example, computing system 130 may correspond to a distributed or cloud-based computing cluster associated with and maintained by the organization, although in other examples, computing system 130 may correspond to a publicly accessible, distributed or cloud-based computing cluster, such as a computing cluster maintained by Microsoft Azure™, Amazon Web Services™, Google Cloud™, or another third-party provider.

In some instances, computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of computing system 130 may perform any of the exemplary processes described herein, to ingest elements of data, to preprocess, consolidate, and aggregate the ingested elements of data, and to store the preprocessed, consolidated, and aggregated data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of computing system 130 may perform operations in parallel that not only train a double machine-learning process using corresponding training and validation datasets extracted from temporally distinct subsets of the preprocessed, consolidated, and aggregated data elements, but also apply the adaptively trained double machine-learning process to input datasets associated with corresponding customers and generate, in real time and for each of the customers, elements of output data indicative of customer-specific values of a treatment elasticity associated with a products available for provisioning by the organization. As described herein, the customer-specific value of the treatment elasticity may characterize, for a customer, an expected change in that customer's interaction with a product available for provisioning by the organization in response to an incremental modification in a rate associated with the product (e.g., in response to a “treatment” applied to the associated rate). For example, the customer's interaction with the available product may be characterized by a “volume” of that product consumed, used, or held by the customer during one or more temporal intervals, and the incremental modification to the rate, e.g., the applied “treatment,” may represent a modification in a per-unit rate to access or use the product (e.g., measured in currency, etc.) or a modification in an interest rate associated with the product (e.g., measured in basis points, etc.).

As described herein, the double machine-learning process may include (i) a first machine-learning or artificial-intelligence process (e.g., a “de-noising process”), which may be trained adaptively to predict, at the temporal prediction point, a customer-specific product volume consumed, used, or held at a temporal endpoint of a future temporal interval; (ii) a second machine-learning or artificial-intelligence process (e.g., a “de-biasing process”), which may be trained adaptively to predict, at the temporal prediction point, treatment offered by the organization for the consumption, use, or holding of the product volume at the temporal endpoint of a future temporal interval; and (iii) a linear-regression process (e.g., an elasticity process) which may be coupled to the output of the first and second machine-learning or artificial-intelligence processes, which may be trained adaptively to predict, at the temporal prediction point, an expected product volume that would result from a product-specific treatment offered by the organization for the product. In some instances, the application of the trained de-noising and de-biasing processes to input datasets derived from data characterizing historical interactions between the customer and the product may reduce, or eliminate, the level of noise and bias present within the input datasets, and the application of trained regression process to the predicted, customer-specific product volumes and treatments may establish a relationship between the predicted product volumes and the predicted treatments across the continuum of possible treatments (e.g., the continuum of possible rates and costs).

Additionally, and through an implementation of the parallelized, fault-tolerant distributed computing and analytical protocols described herein, the distributed components of computing system 130 may perform operations in parallel that train a classifier to label a customer of the organization as a low- or high-treatment-elasticity customer based on using corresponding training and validation datasets that include that customer-specific value of the treatment elasticity and feature values extracted from temporally distinct subsets of the preprocessed, consolidated, and aggregated data elements. The distributed components of computing system 130 may, through an implementation of the parallelized, fault-tolerant distributed computing and analytical protocols described herein, apply the trained classifier to a customer-specific input datasets that include the customer-specific values of the treatment elasticity and the customer-specific feature values, and generate output data that labels the customers associated with each of the customer-specific input datasets as a low- or high-treatment-elasticity customers. As described herein, the assigned labels may facilitate an adjudication of received requests to obtain product-specific exceptions to initially offered, per-unit rates or treatments by the distributed components of computing system 130 using any of the exemplary adjudication processes described herein.

In some instances, and through an implementation of the parallelized, fault-tolerant distributed computing and analytical protocols described herein across the one or more GPUs or TPUs included within the distributed components of computing system 130, certain of the exemplary, computer-implemented processes described herein may accelerate a training, and post-training deployment, of the exemplary machine-learning and artificial-intelligence processes described herein (e.g., the double machine-learning process, the components of the double machine-learning process, and the classifier), when compared to a training and deployment of the machine-learning and artificial-intelligence process across comparable clusters of CPUs capable of processing a single operation per clock cycle.

Referring back to FIG. 1, each of internal source systems 102 may maintain, within corresponding tangible, non-transitory memories, a data repository that includes elements of data associated with, and characterizing, the organization associated with computing system 130, one or more customers of the organization, and the interaction of theses customer with the organization, and one or more products available for provisioning, or previously provisioned, to these customers by the organization across one or more temporal intervals. For example, internal source system 102A may be associated with, or operated by, the organization, and may maintain, within the corresponding one or more tangible, non-transitory memories, a source data repository 106. As described herein, source data repository 106 may include discrete data records that maintain, among other things, elements of profile data that identify and characterize one or more customers of the organization, elements of product data that identify products provisioned by the organization to corresponding ones of the customers of the organization during the one or more temporal intervals and an interaction between these customers and the provisioned products, and elements of exception data that identify and characterize exception requests received from devices operable by customers and/or representatives of the organization, and adjudicated by the organization, during one or more temporal intervals.

The disclosed embodiments are, however, not limited to these exemplary elements of data maintained within the data records of source data repository 106. In other instances, internal source system 102A may maintain, within source data repository 106, any additional, or alternate, elements of data characterizing one or more customers of the organization and the interaction of these customers with the organization, and one or more products provisioned by, or available for provisioning by, the organization to these customers during the one or more temporal intervals, that would be appropriate to the organization and to computing system 130.

Referring back to FIG. 1, each of external source systems 104 may be operated by, or associated with, an organization or entity unrelated to the organization, such as, but not limited to, a reporting, governmental, non-governmental, or judicial entity, and maintain, within corresponding tangible, non-transitory memories, a data repository that includes elements of external data (e.g., values of exogenous variables) that characterize one or more macroeconomic indicators of a regional and/or national economy and/or macroeconomic indicators and pricing data characterizing types of organizations operating within that economy. For example, external source system 104A may maintain, within the corresponding one or more tangible, non-transitory memories, a source data repository 108 having data records that includes, among other things, one or more financial indicators promulgated by a governmental entity, such as, but not limited to, a key or benchmark interest rate established by the Bank of Canada or the Federal Reserve, and pricing data characterizing a baseline rate for products offered by types or groups of organizations (e.g., industry groups, etc.) to customers within corresponding geographic regions. The disclosed embodiments are, however, not limited to these exemplary elements of data maintained within the data records of source data repository 108. In other instances, external source system 104A may maintain, within source data repository 108, any additional, or alternate, values of exogenous variables that would be appropriate to the financial institution and to computing system 130.

To facilitate a performance of the exemplary processes described herein, computing system 130 may maintain, within the one or more tangible memories, a data repository 132 that includes, among other things, an ingested data store 134, a consolidated data store 136, an application data store 138, and a causal inferencing data store 151. Aggregated data store 134 may maintain elements of data ingested from internal source systems 102 (e.g., internal source system 102A) and external source systems 104 (e.g., external source system 104A) during corresponding temporal intervals, and consolidated data store 136 may include data records that maintain pre-processed, filtered, and in some instances, consolidated and/or aggregated, elements of the data ingested by computing system 130 during the corresponding temporal intervals.

Further, as illustrated in FIG. 1, application data store 138 may include, among other things, a training engine 142, an elasticity engine 146, a classification engine 148, and an adjudication engine 150, each of which may be executed by the one or more processors of computing system 130 in accordance with a predetermined schedule, or in response to a request received programmatically from one or more computing systems or devices across network 120. For example, upon execution by the one or more processors of computing system 130, executed training engine 140 may perform any of the exemplary processes described herein to train adaptively the double machine-learning process, including the first machine-learning or artificial-intelligence process (e.g., the de-noising process), the second machine-learning or artificial-intelligence process (e.g., the de-biasing process), and the linear regression process (e.g., the elasticity process), and the classifier based on process-specific training and validation datasets associated with corresponding training and validation intervals.

As described herein, one or more of the first machine-learning or artificial-intelligence process (e.g., the de-noising process), the second machine-learning or artificial intelligence process (e.g., the de-biasing process), and the classifier may include an ensemble or decision-tree process, such as a gradient-boosted decision-tree process (e.g., the XGBoost process), and the regression process may include a linear regression process, such as a multiple linear regression process or an ordinary least squares (OLS) regression process. In other examples, one or more of the first machine-learning or artificial-intelligence process (e.g., the de-noising process), the second machine-learning or artificial intelligence process (e.g., the de-biasing process), and the classifier may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The first machine-learning or artificial-intelligence process (e.g., the de-noising process), the second machine-learning or artificial-intelligence process (e.g., the de-biasing process), and/or the classifier may also include, among other things, a random decision forest, an artificial neural network, a deep neural network, or an association-rule process (e.g., an Apriori algorithm, an Eclat algorithm, or an FP-growth algorithm).

Further, upon completion of one or more of the exemplary training and validation processes described herein, executed training engine 142 may generate, and maintain within causal inferencing data store 151, elements of de-noising process composition data 152, de-biasing process composition data 156, and classifier composition data 160, which characterize a composition of the input dataset (e.g., the sequentially ordered feature values) for respective ones of the trained de-noising process, the trained de-biasing process, and the trained classifier, and elements of de-noising process parameter data 154, de-biasing process parameter data 158, and classifier parameter data 162, which includes values for each of the process parameters associated with respective ones of the trained de-noising process, the trained de-biasing process, and the trained classifier. As described herein, each of the trained de-noising process, trained de-biasing process, and trained classifier may correspond to an ensemble or decision-tree process, such as a gradient-boosted decision-tree process (e.g., an XGBoost process), and the elements of de-noising process parameter data 154, de-biasing process parameter data 158, and classifier parameter data 162 may include, but are not limited to, a learning rate, a number of discrete decision trees, a tree depth characterizing a depth of each of the discrete decision trees, a minimum number of observations in terminal nodes of the decision trees, and/or values of one or more hyperparameters that reduce potential process overfitting. Further, upon completion of one or more of the exemplary training and validation processes described herein, executed training engine 142 may generate, and maintain within causal inferencing data store 151, elasticity process parameters 164 that include, among other things, data identifying each of the independent and dependent variables, regression coefficients of the independent variables, and a corresponding intercept.

Further, upon execution by the one or more processors of computing system 130, executed elasticity engine 146 may perform any of the exemplary processes described herein to apply the trained double machine-learning process to a corresponding, customer-specific input dataset in accordance with elasticity process parameters 164, and based on the application of the trained double machine-learning process to a corresponding, customer-specific input dataset, to generate, in real time, an element of output data indicative of a customer-specific value of a treatment elasticity associated with one or more products available for provisioning by the organization. In some instances, upon execution by the one or more processors of computing system 130, executed classification engine 148 may perform any of the exemplary processes described herein to apply the trained classifier to a customer-specific input dataset that includes the customer-specific value of a treatment elasticity (e.g., having a composition consistent with classifier composition data 160) in accordance with classifier parameter data 162, and based on the application of the trained classifier to a customer-specific input dataset, to generate an element of output data that labels a corresponding customer as either a low-treatment-elasticity customer or a high-treatment-elasticity customer.

Executed classification engine 148 may also perform operations, described herein, that generate an element of classification data 170 that includes, and associates together, a customer identifier of the corresponding customer, the customer-specific value of a treatment elasticity, and the element of output data, which labels the corresponding customer. As illustrated in FIG. 1, the generated element of classification data 170 may be maintained within a corresponding portion of data repository 132, e.g., within casual inferencing data store 151. Further, and upon execution by the one or more processors of computing system 130, executed adjudication engine 150 may perform any of the exemplary processes described herein to adjudicate of customer-specific requests to obtain product-specific exceptions to initially offered, per-unit rates based on the elasticity labels generated by executed classification engine 148 and maintained within classification data 170, and in accordance with one or more adjudication processes.

### B. Exemplary Processes for Training Adaptively Machine-Learning and Artificial-Intelligence Processes

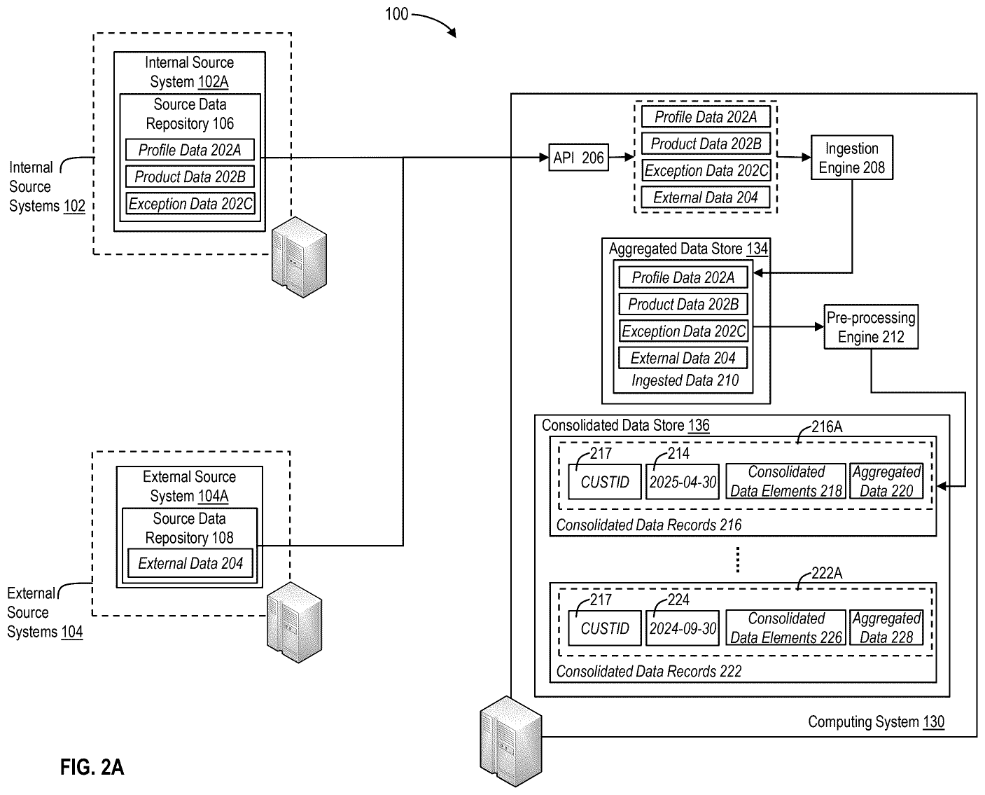

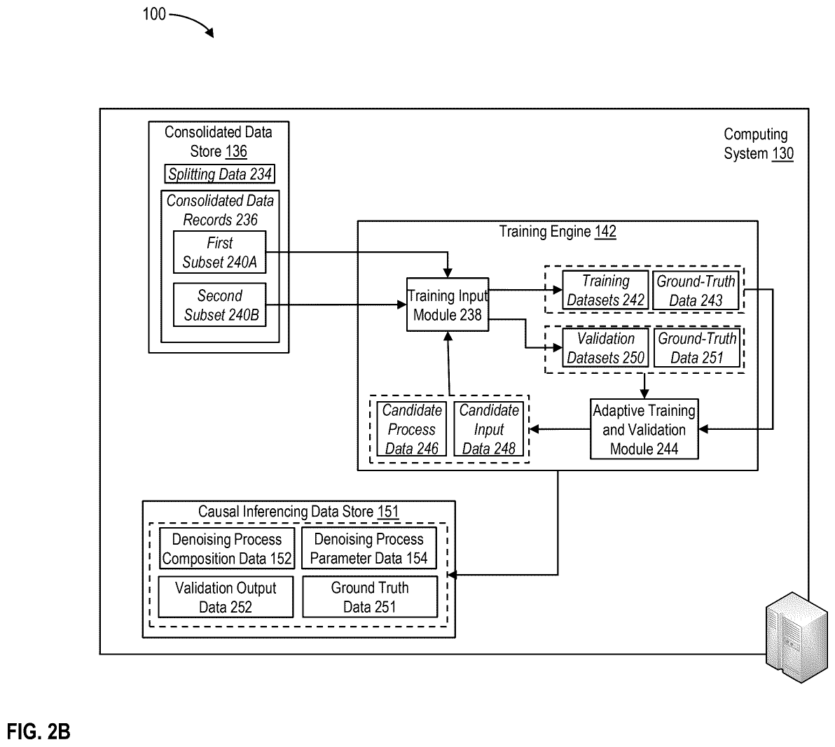

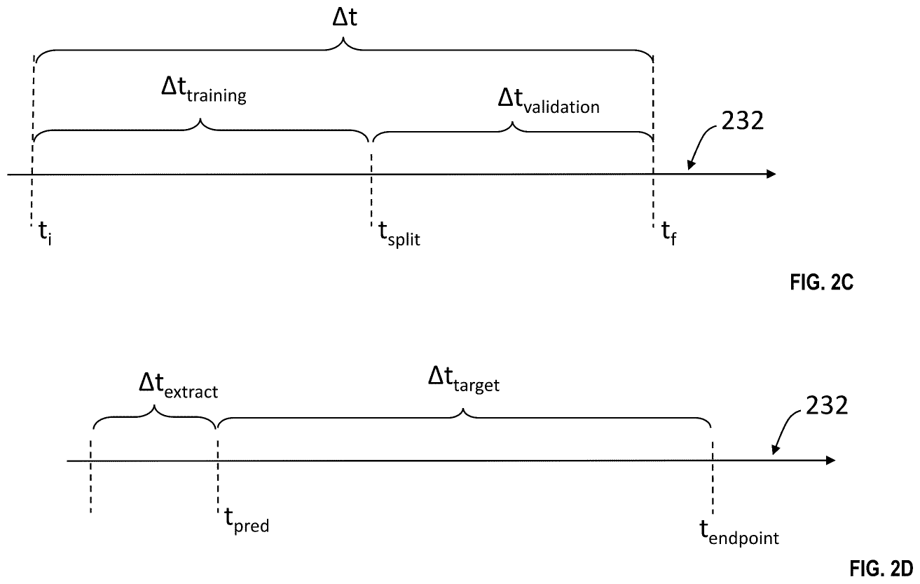

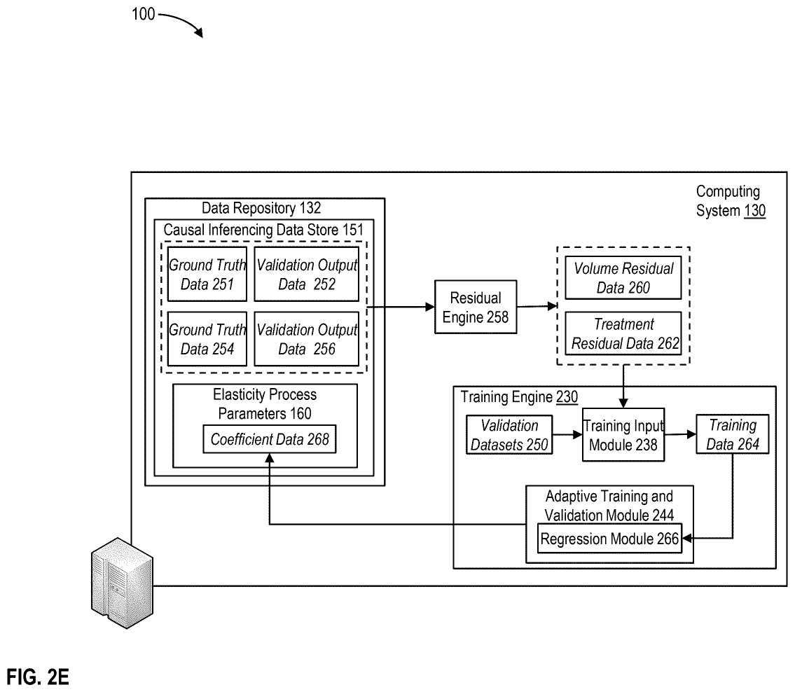

Referring to FIG. 2A, computing system 130 may establish an ingested data store 134, which maintains, among other things, elements of the internal data and external data described herein, which may be ingested by computing system 130 (e.g., from one or more of internal source systems 102 and/or external source systems 104) using any of the exemplary processes described herein. Aggregated data store 132 may, for instance, correspond to a data lake, a data warehouse, or another centralized repository established and maintained, respectively, by the distributed components of computing system 130, e.g., through a Hadoop™ distributed file system (HDFS).

Computing system 130 may execute one or more application programs, elements of code, or code modules that, in conjunction with the corresponding communications interface, establish a secure, programmatic channel of communication with each of internal source systems 102, including source system 102A, and external source systems 104, including external source system 104A, across network 120. In some instances, computing system 130 may also perform operations, described herein, that access and obtain all, or a selected portion, of the elements of internal data and external data described herein from respective ones of internal source systems 102 and external source systems 104.

For example, as illustrated in FIG. 2A, source data repository 106 may maintain elements of profile data 202A, elements of product data 202B, and elements of exception data 202C, and internal source system 102A may perform operations that obtain all, or a selected portion, of the elements of profile data 202A, product data 202B, and exception data 202C from source data repository 106, and that transmit the obtained elements of profile data 202A, product data 202B, and exception data 202C to computing system 130. Further, external source system 102A may perform operations that obtain all, or a selected portion, of the elements of external data 204 from source data repository 108, and that transmit the obtained elements of external data 204 to computing system 130. In some instances, each of internal source systems 102 and external source systems 104 may perform operations that transmit respective elements of profile data 202A, product data 202B, exception data 202C, and external data 204 across network 120 to computing system 130 in batch form and in accordance with a predetermined temporal schedule (e.g., on a daily basis, on a monthly basis, etc.), or in real-time on a continuous, streaming basis.

As described herein, the elements of profile data 202A may include information that identifies and characterizes one or more customers of the organization. By way of example, and for a particular customer, the elements of profile data 202A may include a corresponding, unique customer identifier (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the potential relationship between the particular customer. Further, and as described herein, the elements of product data 202B may include information that identifies products provisioned by the organization to corresponding ones of the customers of the organization during one or more temporal intervals. For example, each of the elements of product data 202B may be associated with a corresponding product and a corresponding customer, and may include a unique customer identifier of the corresponding customer, as described herein, and a unique product identifier of the corresponding product, such as, but not limited to, an alphanumeric character string (e.g., a product name, etc.).

In some instances, and for the corresponding product and the corresponding customer, the elements of product data 202B may also include a value of one or more that product parameters that characterize the corresponding product and/or a consumption, usage, or holding of the corresponding product by the corresponding customer. As described herein, the corresponding product may include a computational resource, such as discrete units of computation resources available for provisioning within a distributed computing cluster (e.g., hours of processor time within a segment of the distributed computing cluster, etc.), and the one or more product parameter values of the computational product may include, but are not limited to, a product volume (e.g., hours of processor time within a segment of the distributed computing cluster, etc.), an offered rate for the provisioned quantity of the computational product (e.g., an hourly rate, a subscription price, etc.), and temporal data characterizing a date on which the corresponding customer purchased the computational product in accordance with the offered rate. For example, the corresponding customer may purchase 1,000 hours of processor time within a segment of the distributed computing cluster on Apr. 15, 2025, at an offered rate of $0.07 per hour, and the elements of product data 202B may include, for the provisioned computational resources, the unique customer identifier of the corresponding customer, an identifier of the provisioned computational resources (e.g., the alphanumeric character string described herein, etc.), and product parameter values that include, but are not limited to, the Apr. 15, 2025, purchase date, the product volume of the provisioned computational resources (e.g., the purchased 1,000 hours) and the offered rate of $0.07 per hour.

Further, and as described herein, the particular provisioned product may also include a financial product, such as a guaranteed investment certificate (GIC), a saving account, or another deposit account, and the one or more product parameter values of the provisioned financial product may include, but are not limited to, a product volume of the financial product (e.g., a balance associated with the provisioned financial product, etc.), an offered rate for the product volume (e.g., an offered interest rate, etc.), and temporal data characterizing a date on which the organization provisioned the product volume of the financial product to the corresponding customer. For example, the corresponding customer may obtain GICs values at $15,000 at an interest rate of 2.97% of Apr. 15, 2025, and the elements of product data 202B may include, for the provisioned financial product, the unique customer identifier of the corresponding customer, an identifier of the provisioned financial product (e.g., the alphanumeric character string identifying he provisioned GIC, as described herein, etc.), temporal data specifying the Apr. 15, 2025, purchase date, and product parameter values that include, but are not limited to, a volume of the provisioned financial product (e.g., the $15,000 value of the provisioned GICs) and the offered interest rate of 2.97%. The disclosed embodiments are, however, not limited to these exemplary computational and financial products, and in other examples, the elements of product data 202B may identify and characterize and additional, or alternate, product available for provisioning to the one or more customer of the organization during corresponding temporal intervals.

In some instances, the elements of exception data 202C may identify and characterize exception requests received from devices operable by customers of the organization, and adjudicated by the organization, during one or more temporal intervals. Each of the received exception requests may be associated with a corresponding one of the customers and may correspond to a request, by the corresponding customer, to obtain an exception to a rate offered initially for a particular product provisioned by the organization, such as, but not limited to, the computational and financial products described herein. For example, the elements of exception data 202C may include, for a particular one of the exception requests, temporal data specifying a date of receipt of the exception request, a unique customer identifier of the corresponding one of the customers (e.g., the alphanumeric character string described herein), a unique product identifier of the particular product associated with the exception request (e.g., the alphanumeric product name described herein), exception data characterizing the exception (e.g., the requested increase, or requested decrease, in the offered rate or treatment, etc.), and adjudication data characterizing the organization's decision regarding the particular one of the exception requests (e.g., data characterizing an approval or denial, a date of adjudication, etc.).

Further, the elements of external data 204 value include values of one or more exogenous variables that characterize one or more macroeconomic indicators of a regional and/or national economy. For example, the elements of external data 204 may include one or more financial indicators promulgated by a governmental entity, such as, but not limited to, a key or benchmark interest rate established by the Bank of Canada or the Federal Reserve, and additional indicators of characterizing types or groups of organizations, such as average rates to access computational resources within distributed computing clusters operable by organizations in one or more geographic regions. The disclosed embodiments are, however, not limited to these exemplary exogenous variables, and in other examples, the elements of external data 204 may include any additional or alternate value of exogenous variables appropriate to train, and subsequently deploy, one or more of the exemplary, trained machine-learning or artificial-intelligence processes described herein.

Referring back to FIG. 2A, a programmatic interface established and maintained by computing system 130, such as application programming interface (API) 206, may receive the elements of profile data 202A, product data 202B, and exception data 202C from internal source system 102A, and may receive the elements of external data 204 from external source system 104A. API 206 may route the elements of profile data 202A, product data 202B, and exception data 202C, and external data 204 to a data ingestion engine 208 executed by the one or more processors of computing system 130, and executed data ingestion engine 208 may also perform operations that store the elements of profile data 202A, product data 202B, and exception data 202C, and external data 204 within ingested data store 134, e.g., as ingested data 210.

Referring back to FIG. 2A, a pre-processing engine 212 executed by the one or more processors of computing system 130 may access ingested data 210, and perform any of the exemplary data pre-processing operations described herein to selectively aggregate, filter, and process portions of the elements of ingested data 210, and to generate consolidated data records 216 (e.g., within consolidated data store 136) associated with the elements of profile data 202A, product data 202B, and exception data 202C, and external data 204 ingested by computing system 130 during a temporal interval, e.g., via any of the exemplary processes described herein.

By way of example, executed pre-processing engine 212 may access the elements of profile data 202A, product data 202B, and exception data 202C, and external data 204 (e.g., as maintained within ingested application data 210), and may perform operations that assign a temporal identifier to each of the accessed data records. In some instances, the temporal identifier may associate each of the accessed elements of profile data 202A, product data 202B, and exception data 202C, and external data 204 with a corresponding temporal interval, which may be indicative of reflect a regularity or a frequency at which computing system 130 ingests the elements of profile data 202A, product data 202B, and exception data 202C, and external data 204 from corresponding ones of internal source systems 102 and external source systems 104. For example, executed data ingestion engine 208 may receive data from corresponding ones of internal source systems 102 and external source systems 104 on a monthly basis (e.g., on the final day of the month), and in particular, may receive the elements of profile data 202A, product data 202B, and exception data 202C, and external data 204 from corresponding ones of source systems 102 on Apr. 30, 2025. In some instances, executed pre-processing engine 212 may generate a temporal identifier 214 associated with the regular, monthly ingestion of the elements of profile data 202A, product data 202B, and exception data 202C, and external data 204 on Apr. 30, 2025 (e.g., “2025 Apr. 30”), and may augment each of the elements of profile data 202A, product data 202B, and exception data 202C, and external data 204 to include generated temporal identifier 214 associated with the temporal interval from Apr. 1, 2025, to Apr. 30, 2025. The disclosed embodiments are, however, not limited to temporal identifiers reflective of a regular, monthly ingestion of data by computing system 130, and in other instances, executed pre-processing engine 140 may augment the elements of profile data 202A, product data 202B, exception data 202C, and external data 204 to include temporal identifiers reflective of any additional, or alternative, temporal interval during which computing system 130 ingests the elements of profile data 202A, product data 202B, exception data 202C, and external data 204.

In some instances, executed pre-processing engine 212 may perform further operations that obtain the elements of profile data 202A, product data 202B, exception data 202C, and external data 204 that include, or are associated with, associated with temporal identifier 214. Executed pre-processing engine 212 may also perform operations that parse the elements of profile data 202A, product data 202B, and exception data 202C and identify subsets of the elements of profile data 202A, product data 202B, and exception data 202C associated with temporal identifier 214 and with corresponding ones of the customers of the organization, e.g., based on the unique customer identifiers included within corresponding ones of the elements of profile data 202A, product data 202B, and exception data 202C. Executed pre-processing engine 212 may also perform operations that, for each of the customer-specific subsets of the elements of profile data 202A, product data 202B, and exception data 202C, generate one or more corresponding elements of consolidated data and aggregated data, which may be stored within a corresponding, customer-specific data record of consolidated data records 216 along with temporal identifier 214 and the corresponding customer identifier, e.g., within consolidated data store 136.

For example, executed pre-processing engine 212 may identify a subset of the elements of profile data 202A, product data 202B, and exception data 202C that are associated with the temporal interval from Apr. 1, 2025, to Apr. 30, 2025 (and temporal identifier 214) and with a corresponding one of the customers having a unique customer identifier 217, e.g., “CUSTID.” In some instances, executed pre-processing engine 212 may store temporal identifier 214 and customer identifier 217 within corresponding data customer-specific data record of consolidated data records 216, e.g., within data record 216A, and may perform any of the exemplary processes described herein to generate, and store within data record 216A, corresponding elements 218 of consolidated data and corresponding elements 220 of aggregated data. By way of example, executed pre-processing engine 140 may consolidate the identified subset of the elements of profile data 202A, product data 202B, and exception data 202C, and the elements of external data 204, into consolidated data elements 218 through an invocation of an appropriate Java-based SQL “join” command (e.g., an appropriate “inner” or “outer” join command, etc.).

Further, in some instances, executed pre-processing engine 212 may also perform operations that aggregate one or more of the identified subsets of the elements of profile data 202A, product data 202B, and exception data 202C, and additionally, or alternatively, the elements of external data 204, and generate corresponding ones of aggregated data elements 220. For example, executed pre-processing engine 212 may apply one or more data-specific aggregation operations to the elements of product data 202B and/or to the elements of exception data 202C, and based on the application of the one or more data-specific aggregation operations to the elements of product data 202B and/or to the elements of exception data 202C, executed pre-processing engine 212 may generate one or more aggregated product parameter values during the temporal interval associated with temporal identifier 214 (e.g., a total volume of the computational product or financial product, and an average daily volume of the computational product or the financial product, etc.) and additionally, or alternatively, one or more aggregated exception values characterizing the customer-specific exception requests received by, or adjudicated by, the organization during the temporal interval associated with temporal identifier 214 (e.g., a total number of exception requests associated with the corresponding customer, data characterizing positive and adjudication decisions, etc.). As described herein, executed pre-processing engine 212 may store the aggregated product parameter values and/or the aggregated exception values within aggregated data elements 220, which may be maintained within data record 216A.

Executed pre-processing engine 212 may perform operations that store customer-specific data record 216A within the one or more tangible, non-transitory memories of computing system 130, such as one of consolidated data records 216 within consolidated data store 136. Consolidated data store 136 may, for instance, correspond to a data lake, a data warehouse, or another centralized repository established and maintained, respectively, by the distributed components of computing system 130, e.g., through a Hadoop™ distributed file system (HDFS). Further, executed pre-processing engine 212 may also perform one or more of the exemplary processes described herein to generate an additional data record of consolidated data records 216 for each additional, or alternate, identified, customer-specific subset of the elements of profile data 202A, product data 202B, and exception data 202C associated with temporal identifier 214, e.g., the temporal interval extending from Apr. 1, 2025, through Apr. 30, 2025.

In some instances, consolidated data store 136 may also maintain a plurality of consolidated data records associated with temporal intervals disposed prior to the one-month temporal interval ending on Apr. 30, 2025, e.g., as associated with consolidated data records 216 and temporal identifier 214. By way of example, as illustrated in FIG. 2A, consolidated data store 136 may include additional data records, such as consolidated data records 222 associated with corresponding ones of the customers of the organization and with a prior temporal interval, such as a prior temporal extending from Sep. 1, 2024, to Sep. 30, 2024. For instance, as illustrated in FIG. 2A, consolidated data records 222 may include a data record 222A associated with the corresponding customer having customer identifier 217, and data record 222A may include customer identifier 217, temporal identifier 224 (i.e., “2024 Sep. 30”) and corresponding ones of consolidated data elements 226 and aggregated data elements 228, which may be generated by executed pre-processing engine 212 using any of the exemplary processes described herein based on elements of profile, product, exception, and external data ingested during the prior temporal interval associated with temporal identifier 224.

The disclosed embodiments are, however, not limited to the exemplary consolidated and aggregated data records described herein, or to the exemplary temporal intervals described herein. In other examples, computing system 130 may generate, and the consolidated data store 136 may maintain, any additional or alternate number of discrete sets of consolidated and aggregated data records, having any additional or alternate composition, that would be appropriate to the elements of profile, product, exception, and external data ingested by computing system 130 at the predetermined intervals described herein. Further, in some examples, computing system 130 may ingest elements of elements of internal or external data from internal source systems 102 and/or external source systems 104 at any additional, or alternate, fixed or variable temporal interval that would be appropriate to the ingested data or to the adaptive training of the machine learning or artificial intelligence processes described herein, including a continuous, real-time ingestion of the elements of elements of profile, product, exception, and external data.

In some instances, computing system 130 may perform any of the exemplary processes described herein to train adaptively a double machine-learning process to predict, at a temporal prediction point, a value of a customer-specific, treatment elasticity with respect to a product provisioned by the organization and further, to train adaptively a classifier that classifies a customer of the organization as a low- or high-elasticity customer based on, among other things, the predicted customer-specific value of the treatment elasticity. The double machine-learning process may, for example, include (i) a first machine-learning or artificial-intelligence process (e.g., a “de-noising process”), which may be trained adaptively to predict, at the temporal prediction point, a customer-specific value of a parameter of a provisioned product (e.g., the product volume described herein) at a temporal endpoint of a future temporal interval; and (ii) a second machine-learning or artificial-intelligence process (e.g., a “de-biasing process”), which may be trained adaptively to predict, at the temporal prediction point, a treatment offered by the organization for the consumption, use, or holding of the product volume at the temporal endpoint of a future temporal interval. As described herein, the treatment may correspond to a difference between an offered rate and a standardized, benchmark, or key rate across the organization, and in some instances, the difference may be averaged over one or more temporal intervals.

The double machine-learning process may also include a linear-regression process (e.g., the elasticity process described herein) coupled to the output of the first and second machine-learning or artificial-intelligence processes, and computing system 130 may perform any of the exemplary processes described herein to train adaptively the linear regression process to predict, at the temporal prediction point, the value of a customer-specific, treatment elasticity with respect to the provisioned product based on, among other things, perturbed and unperturbed values of the customer- and product-specific treatments offered by the organization for the product. In some instances, computing system 130 may perform any of the exemplary processes described herein to train adaptively each of the first machine-learning or artificial-intelligence process, the second machine-learning or artificial-intelligence process, the linear regression process, and the classifier using corresponding, process-specific training datasets associated with a first prior temporal interval (e.g., a “training” interval), and using corresponding process-specific validation datasets associated with a second, and distinct, prior temporal interval (e.g., an out-of-time “validation” interval).

As described herein, one or more of the first machine-learning or artificial-intelligence process, the second machine-learning or artificial-intelligence process, and the classifier may include an ensemble or decision-tree process, such as a gradient-boosted decision-tree process (e.g., the XGBoost process), and the corresponding, process-specific training and validation datasets may include, but are not limited to, values of adaptively selected features obtained, extracted, or derived from the consolidated data records maintained within consolidated data store 136, e.g., from data elements maintained within the discrete data records of consolidated data records 216 or 222. By way of example, the values of adaptively selected features of the training and validation datasets may be obtained, extracted, or derived from the consolidated elements of profile, product, exception, and internal data, and/or the aggregated elements of product and exception data, maintained within the consolidated data records of consolidated data store 136, which characterize corresponding ones of the customers and provisioned products during respective ones of the training and validation intervals.

For example, the distributed computing components of computing system 130 (e.g., that include one or more GPUs or TPUs configured to operate as a discrete computing cluster) may perform any of the exemplary processes described herein to train each of the first machine-learning or artificial-intelligence process, the second machine-learning or artificial-intelligence process, the linear regression process, and the classifier in parallel through an implementation of one or more parallelized, fault-tolerant distributed computing and analytical processes. Based on an outcome of these training processes, computing system 130 may generate process coefficients, parameters, thresholds, and other data that collectively specify corresponding ones of the trained first machine-learning or artificial-intelligence process, the trained second machine-learning or artificial-intelligence process, the trained linear regression process, and the trained classifier, and may store the generated process coefficients, parameters, thresholds, and other data within a portion of the one or more tangible, non-transitory memories, e.g., as de-noising process composition data 152, de-noising process parameter data 154, de-biasing process composition data 156, de-biasing process parameter data 158, elasticity process parameters 164, classifier composition data 160, and classifier parameters 164.

For example, and in reference to FIG. 2B, a training engine 142 executed by the one or more processors of computing system 130 may access the consolidated data records maintained within consolidated data store 136, such as, but not limited to, consolidated data records 216 or additional consolidated data records 222. As described herein, each of the consolidated data records, such as consolidated data records 216 and 222, may include a temporal identifier that associates the consolidated data record with a corresponding temporal interval (e.g., temporal identifiers 216 and 224 of FIG. 2A) and a customer identifier that associates the consolidated data record with a corresponding one of the customers of the organization (e.g., customer identifier 217 of FIG. 2A). Each of the accessed consolidated data records may also include consolidated and/or aggregated elements of corresponding internal and external data (e.g., consolidated data elements 218 and 226, and aggregated data elements 220 and 228 of FIGS. 2A and 2B).

In some instances, executed training engine 142 may parse the accessed consolidated data records, and based on corresponding ones of the temporal identifiers, determine that the consolidated data records are associated with a range of prior temporal intervals. Further, executed training engine 142 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 2C, the range of prior temporal intervals (e.g., shown generally as Δt along timeline 232 of FIG. 2C) may be bounded by, and established by, temporal boundaries tᵢ and t_{f}. Further, the decomposed first subset of the prior temporal intervals (e.g., shown generally as training interval Δt_{training} along timeline 232 of FIG. 2C) may be bounded by temporal boundary tᵢ and a corresponding splitting point tₛₚₗᵢₜ along timeline 232, and the decomposed second subset of the prior temporal intervals (e.g., shown generally as validation interval Δt_{validation} along timeline 232 of FIG. 2C) may be bounded by splitting point tₛₚₗᵢₜ and temporal boundary tr.

Referring back to FIG. 2B, executed training engine 142 may generate elements of splitting data 234 that identify and characterize the determined temporal boundaries of the consolidated data records maintained within consolidated data store 136 (e.g., temporal boundaries tᵢ and t_{f}) and the range of prior temporal intervals established by the determined temporal boundaries Further, the elements of splitting data 234 may also identify and characterize the splitting point (e.g., the splitting point tₛₚₗᵢₜ described herein), the first subset of the prior temporal intervals (e.g., the training interval Δt_{training} and corresponding boundaries described herein), and the second, and subsequent subset of the prior temporal intervals (e.g., the validation interval Δt_{validation} and corresponding boundaries described herein). As illustrated in FIG. 1B, executed training engine 142 may store the elements of splitting data 234 within the one or more tangible, non-transitory memories of computing system 130, e.g., within consolidated data store 136.

In some instances, each of the prior temporal intervals may correspond to a one-month interval, and executed training engine 142 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. For example, the first predetermined percentage may correspond to seventy percent of the consolidated data records, and the second predetermined percentage may correspond to thirty percent of the consolidated data records, although in other examples, executed training engine 142 may compute one or both of the first and second predetermined percentages, and establish the decomposition point, based on the range of prior temporal intervals, a quantity or quality of the consolidated data records maintained within consolidated data store 136, or a magnitude of the temporal intervals (e.g., one-month intervals, two-week intervals, one-week intervals, one-day intervals, etc.).

Further, in some examples, a training input module 238 of executed training engine 142 may perform operations that access all, or a selected subset of, the consolidated data records maintained within consolidated data store 136, e.g., consolidated data records 236. Based on portions of splitting data 234, executed training input module 238 may perform operations that parse the consolidated data records and determine: (i) a first subset 240A of these consolidated data records are associated with the training interval Δt_{training} and may be appropriate to training adaptively the machine-learning or artificial-intelligence process during the training interval; and a (ii) second subset 240B of these consolidated data records are associated with the validation interval Δt_{validation} and may be appropriate to validating the adaptively trained machine-learning or artificial-intelligence process during the validation interval.

As described herein, computing system 130 may perform operations that adaptively train the machine-learning or artificial-intelligence process, such as but not limited to, the first machine-learning or artificial-intelligence process (e.g., a “de-noising process”), to predict, at temporal prediction point, a customer-specific value of a parameter of a provisioned product at a temporal endpoint of a target, future temporal interval using training datasets associated with the training interval, and using validation datasets associated with the validation interval. The de-noising process may, for example, include a gradient-boosted decision-tree process, such as the XGBoost process described herein. Further, and as illustrated in FIG. 2D, executed training engine 142 may perform any of the exemplary processes described herein to train the de-noising process (e.g., the gradient-boosted, decision-tree process described herein) to predict, at a temporal prediction point t_{pred}, the customer-specific product volume at a temporal endpoint t_{endpoint} of a target, future temporal interval Δt_{target} based on input datasets associated with a corresponding prior extraction interval Δt_{extract}. By way of example, the target, future temporal interval Δt_{target} may be characterized by a predetermined duration, such as, but not limited to, two months (e.g., the de-noising process may be trained to predict the customer-specific product volume on a date disposed two-months subsequent to the temporal prediction point t_{pred}), and the prior extraction interval Δt_{extract} may be characterized by a corresponding, predetermined duration, such as, but not limited to, one month, three months, or six months.

Referring back to FIG. 2B, executed training input module 238 may perform operations that access consolidated data records 236 maintained within consolidated data store 136, and parse each of consolidated data records 236 to obtain a corresponding temporal identifier (e.g., which associates the consolidated data record with a corresponding temporal interval). Executed training input module 238 may also perform operations that partition consolidated data records 236 into subsets suitable for training a corresponding one of the machine-learning or artificial-intelligence processes described herein, and for subsequently validating the one or more of the machine-learning or artificial-intelligence processes described herein. By way of example, executed training input module 238 may access splitting data 234, and establish the temporal boundaries for the training interval Δt_{training} (e.g., temporal boundary tᵢ and splitting point tₛₚₗᵢₜ) and the validation interval Δt_{training} (e.g., splitting point tₛₚₗᵢₜ and temporal boundary t_{f}). Further, executed training input module 238 may also parse each of the consolidated data records 236, access the corresponding temporal identifier, and determine the temporal interval associated with the each of consolidated data records 236.

If, for example, executed training input module 238 were to determine that the temporal interval associated with a corresponding one of consolidated data records 236 is disposed within the temporal boundaries for the training interval Δt_{training}, executed training input module 238 may determine that the corresponding data record may be suitable for training, and may perform operations that include the corresponding one of consolidated data records 236 within a portion of the first subset 240A (e.g., that store the corresponding data record within a portion of consolidated data store 136 associated with first subset 240A). Alternatively, if executed training input module 238 were to determine that the temporal interval associated with a corresponding one of consolidated data records 236 is disposed within the temporal boundaries for the validation interval Δt_{validation}, executed training input module 238 may determine that the corresponding data record may be suitable for validation, and may perform operations that include the corresponding one of consolidated data records 236 within a portion of the second subset 240B (e.g., that store the corresponding data record within a portion of consolidated data store 136 associated with second subset 240B). Executed training input module 238 may perform any of the exemplary processes described herein to determine the suitability of each additional, or alternate, one consolidated data records 236 of the customer-specific sets for adaptive training, or alternatively, validation, of the one or more of the machine-learning or artificial intelligence processes described herein (e.g., by filtering the consolidated data records of first subset 240A and second subset 240B in accordance with one or more filtration criteria).

Referring back to FIG. 2B, executed training input module 238 may perform operations that generate a plurality of training datasets 242 based on elements of data obtained, extracted, or derived from all or a selected portion of first subset 240A of the consolidated data records. In some instances, the plurality of training datasets 242 may, when provisioned to an input layer of the gradient-boosted decision-tree process described herein, enable executed training engine 142 to train the gradient-boosted decision-tree process to predict, at a temporal prediction point, a customer-specific product volume of a provisioned product at a temporal endpoint of a future temporal interval, e.g., using training datasets associated with the training interval, and using validation datasets associated with the validation interval

By way of example, each of the plurality of training datasets 242 may be associated with a corresponding one of the customers of the organization and a corresponding temporal interval, and may include, among other things a customer identifier associated with that corresponding customer and a temporal identifier representative of the corresponding temporal interval, as described herein. Each of the plurality of training datasets 242 may also include elements of data (e.g., feature values) that characterize the corresponding one of the customers, the corresponding customer's interaction with the organization or with other, unrelated organizations, the corresponding customer's interaction with products provisioned by the organization, such as those described herein, and a history of requested exceptions to product-specific rates offered by the organization for the products.

Executed training input module 238 may perform operations that identify, and obtain or extract, one or more of the features values from the consolidated data records maintained within first subset 240A and associated with the corresponding one of the customers. The obtained or extracted feature values may, for example, include elements of the profile, product, exception, and external data described herein (e.g., which may populate the consolidated data records maintained within first subset 240A). The disclosed embodiments are, however, not limited to these examples of obtained or extracted feature values, and in other instances, training datasets 242 may include any additional or alternate element of data extracted or obtained from the consolidated data records of first subset 240A, associated with corresponding one of the customers, and associated with the extraction interval Δt_{extract} described herein.

Further, in some instances, executed training input module 238 may perform operations that compute, determine, or derive one or more of the features values based on elements of data extracted or obtained from the consolidated data records maintained within first subset 240A. Examples of these computed, determined, or derived feature values may include, but are not limited to, time-average values of one or more of the product parameter values described herein, sums of one or more of these product parameter values, and sums or time-averaged values characterizing requests for exceptions to product-submitted rates associated with corresponding customers. These disclosed embodiments are, however, not limited to these examples of computed, determined, or derived feature values, and in other instances, training datasets 242 may include any additional or alternate featured computed, determine, or derived from data extracted or obtained from the consolidated data records of first subset 240A, associated with corresponding one of the customers, and associated with the extraction interval Δt_{extract} described herein.

Further, executed training input module 238 may also generate, for each of training datasets 242, a corresponding element of ground-truth data 243. As described herein, the trained de-noising process (e.g., the gradient-boosted, decision-tree process described herein) may predict, at a temporal prediction point t_{pred}, the customer-specific product volume at the temporal endpoint t_{endpoint} of the target, future temporal interval Δt_{target}, e.g., the two-month interval described herein. In some instances, executed training input module 238 may perform operations that, for each of training datasets 242, obtain the corresponding temporal identifier and corresponding customer identifier, access consolidated data records of consolidated data store 136 associated with the corresponding customer identifier, and determine a value of the product volume on a date disposed two-months subsequent to the date specified by corresponding temporal identifier. In some instances, the value of the product volume determined by executed training input module 238 for each of training datasets 242 may correspond to a ground-truth label for the corresponding one of training datasets 242, and executed training input module 238 may perform operations that package the determined value of the product volume into a corresponding elements of ground-truth data 243, e.g., in association with the corresponding one of training datasets 242.

Referring back to FIG. 2B, executed training input module 238 may provide training datasets 242 and the corresponding elements of ground-truth data 243 as an input to an adaptive training and validation module 244 of executed training engine 142. In some instances, and upon execution by the one or more processors of computing system 130, adaptive training and validation module 244 may perform operations that establish a plurality of nodes and a plurality of decision trees for the gradient-boosted, decision-tree process, with may ingest and process the elements of training data (e.g., the customer identifiers, the temporal identifiers, the feature values, etc.) maintained within each of the plurality of training datasets 242. Further, and based on the execution of adaptive training and validation module 244, and on the ingestion of each of training datasets 242 by the established nodes of the gradient-boosted, decision-tree process, computing system 130 may perform operations that train the gradient-boosted, decision-tree process against the elements of training data included within each of training datasets 242.

In some examples, the distributed components of computing system 130 may execute adaptive training and validation module 244 and may perform any of the exemplary processes described herein in parallel to train the gradient-boosted, decision-tree process against the elements of training data included within each of training datasets 242. The parallel implementation of adaptive training and validation module 244 by the distributed components of computing system 130 may, in some instances, be based on an implementation, across the distributed components, of one or more of the parallelized, fault-tolerant distributed computing and analytical protocols described herein.

Through the performance of these exemplary training processes, executed adaptive training and validation module 244 may perform operations that compute one or more candidate process parameters that characterize the trained, gradient-boosted, decision-tree process (e.g., the trained de-noising process), and package the candidate process parameters into corresponding portions of candidate process data 246. In some instances, the candidate process parameters included within candidate process data 246 may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential process overfitting (e.g., regularization of pseudo-regularization hyperparameters).

In some instances, executed adaptive training and validation module 244 may determine certain values of these candidate process parameters using one or more statistical processes, such as via an Optuna™ process that relies on a Bayesian framework. Further, and based on the performance of these exemplary training processes, executed adaptive training and validation module 244 may also generate candidate input data 248, which specifies a candidate composition of an input dataset for the trained, gradient-boosted, decision-tree process (e.g., which be provisioned as inputs to the nodes of the decision trees of the trained, gradient-boosted, decision-tree process).

As illustrated in FIG. 2B, executed adaptive training and validation module 244 may provide candidate process data 246 and candidate input data 248 as inputs to executed training input module 238 of training engine 142, which may perform any of the exemplary processes described herein to generate a plurality of validation datasets 250 having compositions consistent with candidate input data 248 and to generate corresponding elements of ground-truth data 251. As described herein, the plurality of validation datasets 250 may, when provisioned to, and ingested by the corresponding one of the machine-learning or artificial-intelligence processes, enable executed training engine 142 to validate the predictive capability and accuracy of the corresponding the de-noising process, for example, based on elements of ground-truth data 251, or based on one or more computed values of explainable metrics.

The computed metric values may include, but are not limited to, one or more recall-based values for the adaptively trained machine-learning or artificial-intelligence process (e.g., “recall@5,” “recall@10,” “recall@20,” etc.), and additionally, or alternatively, one or more precision-based values for the adaptively trained machine-learning or artificial intelligence process. Further, in some examples, the computed metrics may include a computed value of an area under curve (AUC) for a precision-recall (PR) curve associated with the adaptively trained machine-learning or artificial-intelligence process, and additional, or alternatively, computed value of an AUC for a receiver operating characteristic (ROC) curve associated with the adaptively trained machine-learning or artificial-intelligence process. The disclosed embodiments are, however, not limited to these exemplary computed metric values, and in other instances, executed adaptive training and validation module 244 may compute a value of any additional, or alternate, metric appropriate to validation datasets 250, the elements of ground-truth data, or the adaptively trained machine-learning or artificial-intelligence process (e.g., the adaptively trained, gradient-boosted, decision-tree process described herein).

By way of example, executed training input module 238 may parse candidate input data 248 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 238 and packaged into corresponding potions of training datasets 242, as described herein.

Further, in some examples, each of the plurality of validation datasets 250 may be associated with a corresponding temporal interval within the validation interval Δt_{validation}, and executed training input module 238 may access the consolidated data records maintained within second subset 240B of consolidated data store 136, and may perform operations that extract, from an initial one of the consolidated data records, a temporal identifier (which identifies a temporal interval associated with the initial one of the consolidated data records) and a customer identifier (which identifies the corresponding customer). Executed training input module 238 may package the extracted customer identifier and temporal identifier into portions of a corresponding one of validation datasets 250, e.g., in accordance with candidate input data 248.

Executed training input module 238 may perform operations that access one or more additional ones of the consolidated data records that are associated with the corresponding one of the customers (e.g., that include the customer identifier) and as associated with a temporal interval (e.g., based on corresponding temporal identifiers) disposed prior to the corresponding temporal interval, e.g., within the extraction interval Δt_{extract} described herein. Based on portions of candidate input data 248, executed training input module 238 may identify, and obtain or extract, one or more of the feature values of the validation datasets from within the additional ones of the consolidated data records within second subset 240B. Further, in some examples, and based on portions of candidate input data 248, executed training input module 238 may perform operations that compute, determine, or derive one or more of the features values based on elements of data extracted or obtained from further ones of the consolidated data records within second subset 240B.

Executed training input module 238 may package each of the obtained, extracted, computed, determined, or derived feature values into corresponding positions within the initial one of validation datasets 250, e.g., in accordance with the candidate sequence or position specified within candidate input data 248. Additionally, and in some examples, executed training input module 238 may also perform any of the exemplary processes described herein to generate an element of ground-truth data 251 for each of validation datasets 250.

In some instances, executed training input module 238 may perform any of the exemplary processes described herein to generate additional, or alternate, ones of validation datasets 250 based on the elements of data maintained within the consolidated data records of second subset 240B. For example, each of the additional, or alternate, ones of validation datasets 250 may associated with a corresponding pair of customer and temporal identifiers, and as such, with corresponding customers of the organization and corresponding temporal intervals within validation interval Δt_{validation}. Further, executed training input module 238 may perform any of the exemplary processes described herein to generate an additional, or alternate, one of validation datasets 250 associated with each of the temporal identifiers maintained within the consolidated data records of second subset 240B, and in other instances a number of discrete validation datasets within validation datasets 250 may be predetermined or specified within candidate input data 248.

Referring back to FIG. 2B, executed training input module 238 may provide the plurality of validation datasets 250 as inputs to executed adaptive training and validation module 244. In some examples, executed adaptive training and validation module 244 may perform operations that apply the trained gradient-boosted, decision-tree process to respective ones of validation datasets 250 (e.g., based on the candidate model parameters within candidate process data 246, as described herein), and that generate elements of validation output data 252 based on the application of the trained, gradient-boosted, decision-tree process to corresponding ones of validation datasets 250. As described herein, each of the elements of validation output data may be generated through the application of the trained, gradient-boosted, decision-tree process (e.g., the trained de-noising process) to a corresponding one of validation datasets 250, which may include, among other things, a customer identifier (e.g., identifying a corresponding customer of the financial institution) and a temporal identifier (e.g., identifying a corresponding temporal prediction point).

Further, as described herein, each of elements of validation output data 252 may be include a predicted value of a product volume associated with the corresponding customer at the temporal endpoint t_{pred} of the target, future temporal interval Δt_{target}, e.g., a date two-months subsequent to the corresponding temporal prediction point. By way of example, and as described herein, the predicted product volume may include a predicted product volume of a computational product at the temporal endpoint t_{pred}, such as, but not limited to, a number of units of computation resources provisioned to a customer of a distributed computing cluster on the temporal endpoint t_{pred} (e.g., hours of processor time within a segment of the distributed computing cluster, etc.). Additionally, in some examples, the predicted product volume may include a predicted product volume of a financial product at the temporal endpoint t_{pred}, such as, but not limited to, a total balance of a financial product (e.g., a GIC, etc.) held by the customer the temporal endpoint t_{pred}. The disclosed embodiments are, however, not limited to these exemplary products and predicted product volumes, and in other instances, computing system 130 may perform any of the exemplary processes described herein to train a machine-learning or artificial-intelligence process to predict, at temporal prediction point t_{pred}, a future volume of any additional or alternate product available for provisioning to corresponding customers by the organization.

Executed adaptive training and validation module 244 may perform operations that compute a value of one or more metrics that characterize a predictive capability, and an accuracy, of the trained, gradient-boosted, decision-tree process (e.g., the trained, de-noising process) based on the generated elements of validation output data 252 and corresponding ones of elements of ground-truth data 251. The computed metrics may include, but are not limited to, one or more recall-based values for the trained, gradient-boosted, decision-tree process (e.g., “recall@5,” “recall@10,” “recall@20,” etc.), one or more precision-based values for the adaptively trained machine-learning or artificial-intelligence process, a computed value of an area under curve (AUC) for a precision-recall (PR) curve associated with the adaptively trained machine-learning or artificial-intelligence process, and additional, or alternatively, computed value of an AUC for a receiver operating characteristic (ROC) curve associated with the trained, gradient-boosted, decision-tree process. The disclosed embodiments are, however, not limited to these exemplary computed metric values, and in other instances, executed adaptive training and validation module 244 may compute a value of any additional, or alternate, metric appropriate to validation output data 252, the elements of ground-truth data 251, or the corresponding one of the trained, gradient-boosted, decision-tree process, e.g., the trained de-noising process, trained de-biasing process, and trained classifier described herein.

In some examples, executed adaptive training and validation module 244 may also perform operations that determine whether all, or a selected portion of, the computed metric values satisfy one or more threshold conditions for a deployment of the trained, gradient-boosted, decision-tree process and a real-time application to elements of profile, product, exception, and external data, as described herein. For instance, the one or more threshold conditions may specify one or more predetermined threshold values for the adaptively trained machine-learning or artificial-intelligence, and in some examples, executed adaptive training and validation module 244 that establish whether one, or more, of the computed metric values exceed, or fall below, a corresponding one of the predetermined threshold values and as such, whether the corresponding one of the adaptively trained machine-learning or artificial-intelligence satisfies the one or more threshold requirements for deployment.

If, for example, executed adaptive training and validation module 244 were to establish that one, or more, of the computed metric values fail to satisfy at least one of the threshold requirements, computing system 130 may establish that the trained, gradient-boosted, decision-tree process is insufficiently accurate for deployment. Executed adaptive training and validation module 244 may perform operations (not illustrated in FIG. 2B) that transmit data indicative of the established inaccuracy to executed training input module 238, which may perform any of the exemplary processes described herein to generate one or more additional training datasets and to provision those additional encrypted training datasets to executed adaptive training and validation module 244. In some instances, executed adaptive training and validation module 244 may receive the additional training datasets, and may perform any of the exemplary processes described herein to train further the trained, gradient-boosted, decision-tree process against the elements of training data included within each of the additional training datasets.

Alternatively, if executed adaptive training and validation module 244 were to establish that each computed metric value satisfies threshold requirements, computing system 130 may deem the trained, gradient-boosted, decision-tree process adaptively trained, and ready for deployment. In some instances, executed adaptive training and validation module 244 may generate de-noising process parameter data 154 that includes the process parameters of the trained, gradient-boosted, decision-tree process, such as, but not limited to, each of the candidate model parameters specified within candidate process data 246. Further, executed adaptive training and validation module 244 may also generate de-noising composition data 152, which characterizes a composition of an input dataset for the trained, gradient-boosted, decision-tree process and identifies each of the discrete data elements within the input data set, along with a sequence or position of these elements within the input data set (e.g., as specified within candidate input data 248). As illustrated in FIG. 2B, executed adaptive training and validation module 244 may perform operations that store de-noising composition data 152 and de-noising process parameter data 154, and that store the elements of ground-truth data 251 and validation output data 252, within the one or more tangible, non-transitory memories of computing system 130, such as causal inferencing data store 151.

Through a performance of one or more of the exemplary processes described herein, computing system 130 may train adaptively a first machine-learning or artificial intelligence process, such as the de-noising process, to predict, at the temporal prediction point, a customer-specific value of a parameter of a provisioned product, such as a product volume of that provisioned product used, consumed, or held by a corresponding customer, a temporal endpoint of a future temporal interval. The temporal endpoint may, in some instances, correspond to a date disposed two-months subsequent to the temporal prediction point, and as described herein, the trained de-noising process may include a trained, gradient-boosted decision process. Further, in some examples, computing system 130 may also perform any of the exemplary training and validation processes described herein to train adaptively one or more additional, or alternate, gradient-boosted decision processes, such as, but not limited to, the de-biasing process and the classifier described herein, using corresponding, process-specific training datasets associated with a first prior temporal interval (e.g., the training interval described herein), and using corresponding process-specific validation datasets associated with a second, and distinct, prior temporal interval (e.g., the out-of-time validation interval described herein).

By way of example, executed training engine 142 may perform operations, described herein, that train a second machine-learning or artificial intelligence process, such as the de-biasing process, to predict, at the temporal prediction point, a treatment offered by the organization, and associated with the consumption, use, or holding of the product volume at the temporal endpoint of a future temporal interval, using training and validation datasets associated with corresponding ones of the training and validation intervals described herein. As described herein, the treatment may correspond to a difference between an offered rate and a standardized, benchmark, or key rate across the organization (and in some instances, the difference may be averaged over one or more temporal intervals), and the temporal endpoint may correspond to a date disposed two-months subsequent to the temporal prediction point. Further, in some instances, a composition of the training and validation datasets for the de-biasing model may each have a composition consistent with the elements of de-noising process composition data 152, and as described herein, the de-noising process and the de-biasing process may each correspond to a gradient-boosted decision process, such as the XGBoost process.

Further, executed training engine 142 (e.g., via executed adaptive training and validation module 244) may also perform any of the exemplary processes described herein to compute a value of one or more metrics that characterize a predictive capability, and an accuracy, of the trained, de-biasing process based on generated elements of validation output data and corresponding elements of process-specific ground-truth data. In some instances, each of the elements of ground-truth data may be associated with a corresponding one of the process-specific validation datasets (e.g., and with a corresponding customer and a corresponding temporal interval), and the elements of ground-truth data associated with the trained de-biasing process may include an actual rate offered by the organization to the corresponding customer for the provisioned product, or a treatment representing a difference between the actual offered rate and a standardized, key or benchmark rate (e.g., a customer-specific “treatment” applied to the provisioned product), and the temporal endpoint of the target, future temporal interval disposed subsequent to the corresponding temporal interval.

In some instances, executed training engine 142 (e.g., via executed adaptive training and validation module 244) may establish that each of the computed metric values satisfies one or more threshold requirements, such as those described herein, and computing system 130 may deem the trained, de-biasing process ready for deployment. Based on the successful validation of the trained de-biasing process, executed training engine 142 may perform operations, described herein, to generate de-biasing process parameter data 158 that includes the process parameters of the trained, de-biasing process, and to generate de-biasing composition data 156, which characterizes a composition of an input dataset for the trained de-biasing process and identifies each of the discrete data elements within the input data set, along with a sequence or position of these elements within the input data set. As described herein, executed training engine 142 may store de-biasing composition data 156 and de-biasing process parameter data 158, and may store elements of validation output and ground-truth data characterizing the validation of the trained de-biasing process, within the one or more tangible, non-transitory memories of computing system 130, such as causal inferencing data store 151.

Additionally, in some examples, executed training engine 142 may perform any of the exemplary processes described herein to train a classifier to classifies a customer of the organization as a low- or high-treatment-elasticity customer based on using process-specific training datasets associated with a corresponding training interval and process-specific validation datasets associated with a corresponding validation interval. As described herein, the training and validation datasets for the classifier may each be associated with a corresponding temporal interval and a corresponding customer, and may include one or more of the exemplary feature values described herein. Further, in some examples, the training and validation datasets for the classifier may also include, for the corresponding customer, a customer-specific value of the treatment elasticity determined by computing system 130 using any of the exemplary processes described herein and additional data characterizing the corresponding customer and an interaction of the corresponding customer with the organization and/or products provisioned by the organization, such as, but not limited to, one or more of the feature values of training datasets 242 and validation datasets 250.

Executed training engine 142 (e.g., via executed adaptive training and validation module 244) may also perform any of the exemplary processes described herein to compute a value of one or more metrics that characterize a predictive capability, and an accuracy, of the trained classifier based on generated elements of validation output data and corresponding elements of process-specific ground-truth data. In some instances, each of the elements of ground-truth data may be associated with a corresponding one of the process-specific validation datasets (e.g., and with a corresponding customer and a corresponding temporal interval), and the elements of ground-truth data associated with the trained classifier may include an elasticity label indicating the classification of the corresponding customer as a low- or high-treatment-elasticity customer.

In some instances, executed training engine 142 (e.g., via executed adaptive training and validation module 244) may establish that each of the computed metric values satisfies one or more threshold requirements, such as those described herein, and computing system 130 may deem the trained classifier ready for deployment. Based on the successful validation of the trained classifier, executed training engine 142 may perform operations, described herein, to generate classifier parameter data 162 that includes the process parameters of the trained classifier, and to generate classifier composition data 160, which characterizes a composition of an input dataset for the trained classifier (e.g., including the customer-specific value of the treatment elasticity) and identifies each of the discrete data elements within the input data set, along with a sequence or position of these elements within the input data set. As described herein, executed training engine 142 may store classifier composition data 160 and classifier parameter data 162 within the one or more tangible, non-transitory memories of computing system 130, such as causal inferencing data store 151.

Further, as described herein, the double machine-learning process may also include a linear-regression process (e.g., the elasticity process described herein) coupled to the output of the first and second machine-learning or artificial-intelligence processes, and computing system 130 may perform any of the exemplary processes described herein to train adaptively the linear regression process to predict, at the temporal prediction point, an expected value of a parameter of a provisioned product, such as the product volume, that would result from a product-specific rate or rate treatment offered by the organization for the product. For example, as illustrated in FIG. 2E, executed training engine 142 may obtain, from causal inferencing data store 151, the elements of ground-truth data 251 and validation output data 252 associated with the validation of the trained de-noising process (e.g., the first trained machine-learning or artificial-intelligence process described herein), and elements of ground truth data 254 and validation output data 256 associated with the validation of the trained de-biasing process (e.g., the second trained machine-learning or artificial-intelligence process described herein),

As described herein, each of the elements of validation output data 252 may be generated through the application of the trained de-noising process to a corresponding one of validation datasets 250, which may include, among other things, a customer identifier (e.g., identifying a corresponding customer of the organization), a temporal identifier (e.g., identifying a corresponding temporal prediction point), and a predicted value of a product volume associated with the corresponding customer at the temporal endpoint t_{pred} of the target, future temporal interval Δt_{target}, e.g., a date two-months subsequent to the corresponding temporal prediction point. Further, as described herein, each of the elements of ground-truth data 251 may be associated with a corresponding element of validation output data 252 (and as such, with the corresponding customer and the corresponding temporal prediction point), and each of the elements of ground-truth data 251 may specify the actual value of a product volume associated with the corresponding customer at the temporal endpoint t_{pred} of the target, future temporal interval Δt_{target}.

Further, each of the elements of validation output data 256 may be generated through the application of the trained de-biasing process to a corresponding one of the validation datasets 250, which may include, among other things, the customer identifier (e.g., identifying the corresponding customer of the organization), the temporal identifier (e.g., identifying the corresponding temporal prediction point), and a predicted value of a treatment offered by the organization to the corresponding customer (e.g., to support the use, consumption, or holding of the provisioned product) at the temporal endpoint t_{pred} of the target, future temporal interval Δt_{target}, e.g., the date two-months subsequent to the corresponding temporal prediction point. As described herein, the treatment may correspond to a difference between an offered rate and a standardized, benchmark, or key rate across the organization, and in some instances, the difference may be averaged over one or more temporal intervals. Further, as described herein, each of the elements of ground-truth data 254 may be associated with a corresponding element of validation output data 256 (and as such, with the corresponding customer and the corresponding temporal prediction point), and each of the elements of ground-truth data 254 may specify the actual rate treatment offered by the organization to the corresponding customer for the provisioned product at the temporal endpoint t_{pred} of the target, future temporal interval Δt_{target}.

In some instances, a residual module 258 of executed training engine 142 may receive ground-truth data 251 and validation output data 252 associated with the trained de-noising process, and executed training engine 142 may receive ground-truth data 254 and validation output data 256 associated with the trained de-biasing process. Executed residual module 258 may, for example, access an element of ground truth data 251 and a corresponding element of validation output data 252, which may each be associated with a corresponding customer of the organization. Executed residual module 258 may perform operations that compute a value of a volume residual for the corresponding customer based on a difference between the actual value of the product volume (e.g., maintained within the element of ground-truth data 251) and the predicted value of the product volume, which may be maintained within the element of validation output data 252. In some instances, executed residual module 258 may package the volume residual value associated with the corresponding customer into an element of volume residual data 260, along with the customer identifier of the corresponding customer and the corresponding temporal identifier maintained within validation output data 256. Further, executed residual module 258 may also perform one or more of the exemplary processes described herein to generate an additional element of volume residual data 260 for the corresponding customer associated with each additional, or alternate, pair of elements of ground-truth data 251 and validation output data 252.

Executed residual module 258 may perform operations that compute a value of a treatment residual for the corresponding customer based on a difference between the actual value of the value of the rate treatment offered by the organization to the corresponding customer (e.g., maintained within the element of ground-truth data 254) and the predicted value of rate treatment, which may be maintained within the element of validation output data 256. In some instances, executed residual module 258 may package the treatment residual value associated with the corresponding customer into an element of treatment residual data 262, along with the customer identifier of the corresponding customer and the corresponding temporal identifier maintained within validation output data 256. Further, executed residual module 258 may also perform one or more of the exemplary processes described herein to generate an additional element of treatment residual data 262 for the corresponding customer associated with each additional, or alternate, pair of elements of ground-truth data 254 and validation output data 256.

In some instances, executed residual module 258 may provision the elements of volume residual data 260 and treatment residual data 262 as input to executed training input module 238, which may also obtain validation datasets 250 from a corresponding portion of the one or more tangible, non-transitory memories of computing system 130 (e.g., from consolidated data store 136). As described herein, each of validation datasets 250, and each element of treatment residual data 262, may include a customer identifier of a corresponding customer and a temporal identifier of a corresponding temporal prediction point. Further, and as described herein, each of validation datasets 250 may also include customer-specific feature values that characterize the corresponding one of the customers, the corresponding customer's interaction with the organization or with other, unrelated organizations, the corresponding customer's interaction with products provisioned by the organization, such as those described herein, and a history of requested exceptions to product-specific rates offered by the organization for the products.

For each of the customer identifiers (and for each of the corresponding customers), executed training input module 238 may obtain the customer-specific value of the treatment residual from the corresponding element of treatment residual data 262, and may obtain all, or a selected subject, of the customer-specific feature values from the corresponding one of validation datasets 250. Executed training input module 238 that package each of the customer identifiers and the associated temporal identifier into a corresponding element of training data 264, along with the obtained, customer-specific value of the treatment residual and the obtained customer-specific feature values. In some instances, executed training input module 238 may provide the elements of training data 264 and the elements of volume residual data 260 (e.g., that include the customer-specific values of the volume residual) as inputs to executed adaptive training and validation module 244, which may perform operations that apply a linear regression process to each of the elements of training data 264 and to corresponding elements of volume residual data 260, and that generate elements of regression coefficient data 268 that specifies a linear relationship between (i) the customer-specific values of the volume residuals and (ii) the customer-specific values of treatment residual and the customer-specific feature values.

In some instances, a regression module 266 of executed adaptive training and validation module 244 may perform operations that apply the linear regression process to each of the each of the elements of training data 264 and to corresponding ones of the elements of volume residual data 260, e.g., treating each of the customer-specific values of the volume residuals as a dependent variable, and treating the customer-specific values of treatment residual and the customer-specific feature values as independent variables associated with corresponding regression coefficients. The regression process may, for example, include a multiple linear regression process or an ordinary least squares (OLS) regression process, and based on the application of the linear regression process to each of the elements of training data 264, executed regression module 266 may generate elements of coefficient data 268, which may include a value of an intercept and regression coefficients for each of the independent variables described herein.

Executed training engine 230 may store the elements of coefficient data 268 within a portion of causal inferencing data store 151, e.g., within elasticity process parameters 164. In some instances, executed training engine 142 may perform operations that evaluate an accuracy of the trained regression process based on a comparison between the customer-specific values of product volumes computed from groups of customers of the organization using the trained regression process and corresponding values of determined for these customers using conventional, randomized control trials or heterogenous treatment effect models. The accuracy of the trained elasticity process may, in some instances, be visualized using a cumulative gain curve.

### C. Exemplary Processes for Classifying Treatment Elasticity and Adjudicating Exceptions Using Trained, Double Machine-Learning Processes

Through a performance of one or more of the exemplary processes described herein, computing system 130 may train adaptively a double machine-learning process to predict, at a temporal prediction point, a value of a customer-specific, treatment elasticity with respect to a product provisioned by the organization and further, may train adaptively a classifier that classifies a customer of the organization as a low- or high-elasticity customer based on, among other things, the predicted customer-specific value of the treatment elasticity generated by the trained, double machine-learning process. The double machine-learning process may, for example, include (i) a first machine-learning or artificial-intelligence process (e.g., the de-noising process described herein), which may be trained adaptively to predict, at the temporal prediction point, a customer-specific value of a parameter of a provisioned product (e.g., the product volume described herein) at a temporal endpoint of a future temporal interval; (ii) a second machine-learning or artificial-intelligence process (e.g., the de-biasing process described herein), which may be trained adaptively to predict, at the temporal prediction point, a treatment offered by the organization, and associated with the consumption, use, or holding of the product volume, at the temporal endpoint of a future temporal interval; and (iii) a linear-regression process (e.g., the elasticity process described herein) coupled to the output of the first and second machine-learning or artificial-intelligence processes, which may be trained adaptively to predict, at the temporal prediction point, an expected, customer-specific value of a parameter of a provisioned product, such as the product volume, that would result from a product-specific rate or rate treatment offered by the organization for the product. As described herein, the treatment may correspond to a difference between an offered rate and a standardized, benchmark, or key rate across the organization, which may be averaged over one or more temporal intervals. In some instances, computing system 130 may perform any of the exemplary processes described herein to train the de-noising process, the de-biasing process, and the classifier using corresponding, process-specific training datasets associated with a first prior temporal interval (e.g., a “training” interval), and using corresponding process-specific validation datasets associated with a second, and distinct, prior temporal interval (e.g., an out-of-time “validation” interval).

As described herein, one or more of the first machine-learning or artificial-intelligence process, the second machine-learning or artificial intelligence process, and the classifier may include an ensemble or decision-tree process, such as a gradient-boosted decision-tree process (e.g., the XGBoost process), and the corresponding, process-specific training and validation datasets may include, but are not limited to, values of adaptively selected features obtained, extracted, or derived from the consolidated data records maintained within consolidated data store 136, e.g., from data elements maintained within the discrete data records of consolidated data records 216 or 222. By way of example, the values of adaptively selected features of the training and validation datasets may be obtained, extracted, or derived from the consolidated elements of profile, product, exception, and external data, and/or the aggregated elements of product and exception data, maintained within the consolidated data records of consolidated data store 136, which characterize corresponding ones of the customers and provisioned products during respective ones of the training and validation intervals.

In other examples, described herein, computing system 130 may perform one of more of the exemplary processes described herein to apply the trained, causal inferencing to customer-specific input datasets that include, among other things, data that characterizes at least a subset of the customers of the organization, interactions between these customers and the organization or with other, unrelated organizations, interactions between these customers and products provisioned by the organization, such as those described herein, and a history of requested exceptions to product-specific rates offered by the organization for the products. Based on the application of the trained, double machine-learning process to the customer-specific input datasets, computing system 130 may perform any of the exemplary processes described herein to determine, for each of the customers, value of a customer-specific, treatment elasticity with respect to a product provisioned by the organization, and as described herein, the value of the customer-specific, treatment elasticity may specify an expected change in a value of a parameter of the product provisioned to the corresponding customer (e.g., a consumption, usage, or holding of the provisioned product) in response to a modification to the treatment offered by the organization for the provisioned product.

Further, and based on the determined values of the customer-specific, rate elasticities for the subject of the customers, computing system 130 may also perform operations, described herein, that classify each of the subset of customers as a low- or high-treatment-elasticity customer. For example, computing system 130 may apply the trained classifier to customer-specific input datasets that include, among other things, the corresponding value of the customer-specific, treatment elasticity and additional feature values that characterize the corresponding customer and an interaction of the corresponding customer with the organization and/or products provisioned by the organization, such as, but not limited to, one or more of the feature values of training datasets 242 and validation datasets 250. In some instances, based on the application of the trained classifier to each of the customer-specific input datasets, computing system 130 may generate customer-specific labelling data that characterize each of the subset of customers as either a low-treatment-elasticity customer, which indicates that the customer's usage the provisioned product may remain stable in response to a change in an offered treatment for the provisioned product, or alternatively, a high-treatment-elasticity customer, which indicates that the customer's usage the provisioned product may change in response to a change in an offered treatment for the provisioned product.

Computing system 130 may also perform operations, described herein, that generate an element of classification data 170 that includes, for each of the subset of the customers, a corresponding customer identifier (e.g., the alphanumeric character string described herein), the customer-specific value of the treatment elasticity, and the customer-specific label, e.g., as a low- or high-treatment-elasticity customer. In some instances, and as described herein, computing system 130, or one or more additional computing systems or devices associated with the organization, may perform operations that adjudicate received, customer-specific requests to obtain an exception to a rate initially offered by the organization based on the customer-specific labelling data that characterizes the corresponding customer as a low- or high-treatment-elasticity customer.

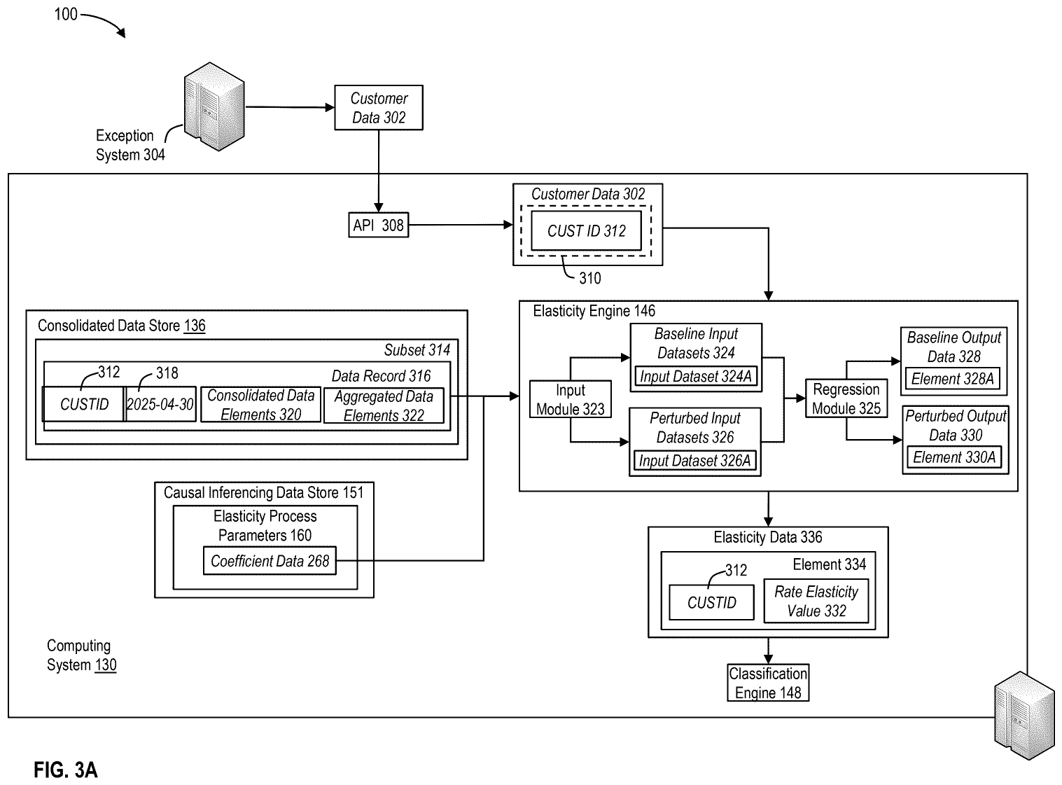

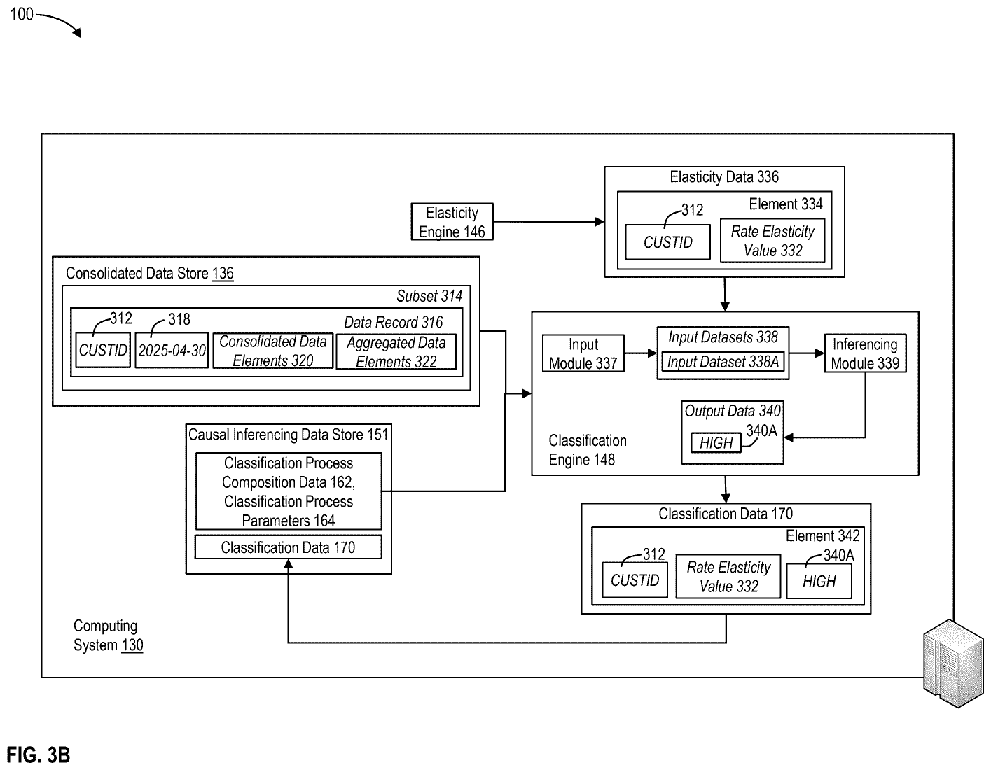

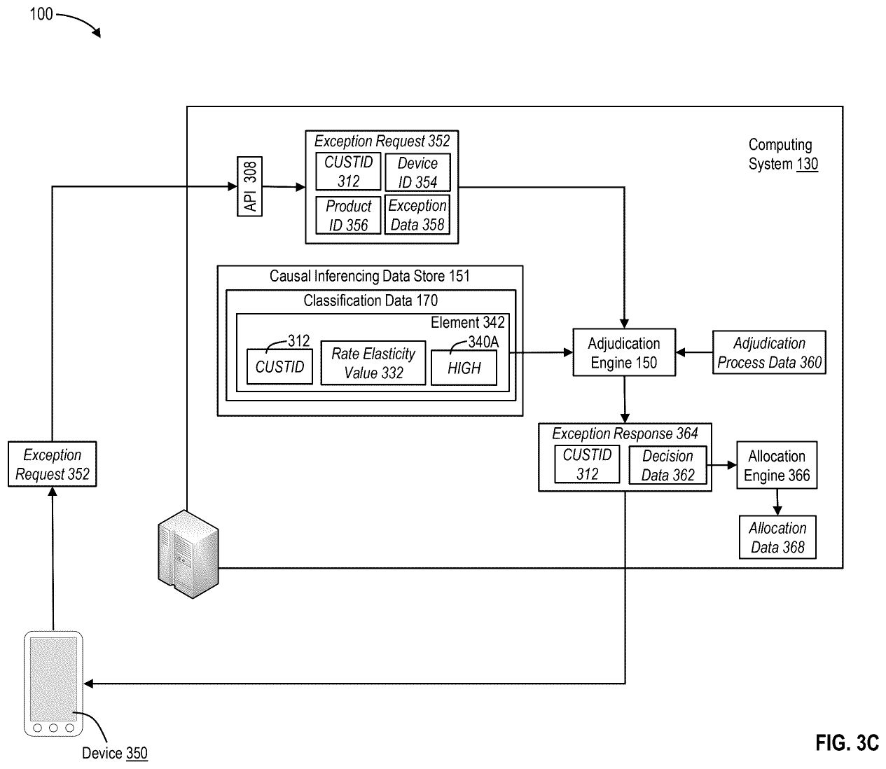

Referring to FIG. 3A, elasticity engine 146 executed by the one or more processors of computing system 130 may receive elements of customer data 302, which includes a unique, customer identifier (e.g., the alphanumeric character string described herein) for all, or a selected subset, of customers of the organization subject to classification labelling using any of the exemplary processes described herein. In some instances, executed elasticity engine 146 may obtain the elements of customer data 302 from one or more tangible, non-transitory memories of computing system 130 (e.g., from data repository 132) in accordance with a predetermined schedule, such as, but not limited to, on bi-weekly, monthly, or quarterly basis. In other instances, one or more additional computing systems associated with the organization, such as an exception system 304, may transmit at least a portion of the elements of customer data 302 across network 120 to computing system 130 in accordance with the predetermined temporal schedule, or in response to an exception request received from a correspondence device operable by a customer. For example, a programmatic interface established and maintained by computing system 130, such as application programming interface (API) 308, may receive the portions of customer data 302 from exception system 304, or from additional, or alternate, ones of the issuer systems, and API 308 may route each of the elements of customer data 302 to executed elasticity engine 146.

In some instances, exception system 304 may represent a computing system that includes one or more servers and tangible, non-transitory memories storing executable code and application modules. Further, the one or more servers may each include one or more processors (such as a central processing unit (CPU)), which may be configured to execute portions of the stored code or application modules to perform operations consistent with the disclosed embodiments. Exception system 304 may also include a communications interface, such as one or more wireless transceivers, coupled to the one or more processors for accommodating wired or wireless internet communication with other computing systems and devices operating within environment 100. In some instances, exception system 304 may be incorporated into a respective, discrete computing system, although in other instances, exception system 304 may correspond to a distributed computing system having a plurality of interconnected, computing components distributed across an appropriate computing network, such as communications network 120 of FIG. 1A, or to a publicly accessible, distributed or cloud-based computing cluster.

Referring back to FIG. 3A, executed elasticity engine 146 may parse the elements of customer data 302 and may access each of the customer identifiers associated with the corresponding customers. In some instances, executed elasticity engine 146 may perform any of the exemplary processes to generate an input dataset associated with each of the corresponding customers, and based on an application of the trained double machine-learning process to each of the generated input datasets, elasticity engine 146 may perform operations that generate a customer-specific value of an treatment elasticity with respect to a provisioned product, such as, but not limited to, the computational resources and financial products described herein. For example, the customer-specific value of the treatment elasticity may characterize an expected change in a value of a parameter of the provisioned product, such as the product volume described herein, in response to a modification to the customer-specific treatment offered by the organization for the provisioned product.

In some instances, executed elasticity engine 146 may access an element 310 of customer data 302, which may be associated with a particular one of the customer of the organization, and which may include a customer identifier 312 assigned to the particular customer by computing system 130 (e.g., an alphanumeric character string, etc.). Further, although not illustrated in FIG. 3A, each additional, or alternate, element of customer data 302 may be associated with an additional customer of the organization and may include a customer identifier associated with that additional customer.

Executed elasticity engine 146 may also access consolidated data store 136, and perform operations that identify, within consolidated data store 136, a subset 314 of consolidated data records that include customer identifier 312 and as such, are associated with the particular customer of the organization identified by element 310 of customer data 302. As described herein, each of the consolidated data records maintained within consolidated data store 136 may be associated with a customer of the organization, and may characterize that customer, the interaction of that customer with the organization and with products provisioned by that organization, and exceptions to product-submitted rates associated with these customers during corresponding temporal interval. For example, and as described herein, each of the consolidated data records may include a corresponding customer identifier (e.g., an alphanumeric character string assigned to a corresponding customer), a corresponding temporal identifier (e.g., that identifies the corresponding temporal interval), and one or more consolidated and aggregated data elements associated with the corresponding customer, as described herein.

In some instances, and as illustrated in FIG. 3A, each data record within subset 314 may include customer identifier 312 and as such, may be associated with the particular customer identified by element 310 of customer data 302. Each of subset 314 of the consolidated data records may also include a temporal identifier of a corresponding temporal interval, and one or more consolidated and aggregated data elements associated with the particular customer, the interaction of the particular customer with the organization and with products provisioned by that organization, and exceptions to product-submitted rates associated with the particular customers during corresponding ones of the temporal intervals By way of example, data record 316 of subset 314 may include customer identifier 312, a corresponding temporal identifier 318 (e.g., “2025 Apr. 30,” indicating a temporal interval spanning Apr. 1, 2025, through Apr. 30, 2025), and consolidated data elements 320 and aggregated data elements 322, each of which identify and characterize the particular customer during the temporal interval.

Executed elasticity engine 146 may also access causal inferencing data store 151 and obtain the elements of coefficient data 268 associated with the trained regression process. As described herein, the elements of coefficient data 268 may specify each of the independent variables associated with the trained regression process, and examples of these independent variables include, but are not limited to, a treatment offered by the organization for the provisioned product and all, or a subset, of the feature values included within validation datasets 250, which characterize corresponding customers of the organization, interactions of these customers with the organization and/or products provisioned by the organization, and/or exceptions to initially offered rates associated with these customers.

Based the consolidated and aggregated data elements maintained within the accessed consolidated data records, an input module 323 of executed elasticity engine 146 may perform operations that generate, for each of the customer identifiers within customer data 302, a corresponding one of baseline input datasets 324 and perturbed input datasets 326, each of which have compositions consistent with coefficient data 268. For example, executed input module 323 may perform operations, consistent with coefficient data 268, that compute values of the independent variables based on subset 314 of consolidated data records associated with customer identifier 312, and that package the generated, customer-specific independent variables into corresponding portions of baseline input dataset 324A and perturbed input dataset 326A. Further, and consistent with the elements of coefficient data 268, executed input module 323 may also perform operations that generate a baseline treatment offered by the organization for the provisioned product and a perturbed treatment for the provisioned product, and that package the baseline treatment and the perturbed rate treatment into respective ones of baseline input dataset 324A and perturbed input dataset 326A.

In some instances, the baseline treatment may correspond to an average rate offered by the organization for the provisioned product during one or more prior temporal intervals. For example, the average treatment offered by the organization for the provisioned product may correspond a weighted average of a difference between the rates offered by the organization during the one or more temporal intervals and a key, benchmark, or standardized rate offered across multiple organization or within a geographic area. Further, the perturbed treatment may reflect a modification of a predetermined magnitude to the baseline treatment, such as, but not limited to a percentage increase or decrease in the baseline rate (e.g., 5%, 10%, etc.) or an increase or decrease of a predetermined number of basis points (e.g., ten basis points, twenty, basis points, etc.).

The disclosed embodiments are, however, not limited to these exemplary baseline or perturbed rates (or rate treatments), and in other instances, executed elasticity engine 146 may generate any additional or alternate baseline treatment or perturbed treatment that would be appropriate to the trained repression process or the provisioned product. Further, in some instances, executed input module 323 may also perform any of the exemplary processes described herein to generate an additional one of baseline input datasets 324 and perturbed input datasets 326 based on the consolidated data records associated with each additional, or alternate, customer identifier maintained within the elements of customer data 302.

In some instances, a regression module 325 of executed elasticity engine 146 may perform operations that apply the trained regression process to each dataset of baseline input datasets 324, including baseline input dataset 324A, in accordance with the coefficients and intercept set forth in coefficient data 268, and generate a corresponding element of baseline output data 328. Further, executed regression module 325 \may also perform operations that apply the trained regression process to each dataset of perturbed input datasets 326, including baseline input dataset 324A, in accordance with the coefficients and intercept set forth in coefficient data 268, and generate a corresponding element of perturbed output data 330. For example, as illustrated in FIG. 3A, baseline output data 328 includes output data element 328A associated with customer identifier 312 and generated through the application of the trained regression process to baseline input dataset 324A, and perturbed output data 330 includes output data element 330A associated with customer identifier 312 and generated through the application of the trained regression process to perturbed input dataset 326A.

Further executed elasticity engine 146 may determine, for each of the customer identifiers maintained within the elements of customer data 302, a value of a customer-specific, treatment elasticity with respect to a product provisioned by the organization based on a computed difference between the corresponding elements of perturbed output data 330 and baseline output data 328. As described herein, the elements of perturbed output data 330 and baseline output data 328 may represent predicted values of the product parameter of the provisioned product, e.g., the product volume, expected to result from respective ones of the perturbed treatment or the baseline treatment, and the difference between the corresponding elements of perturbed output data 330 and baseline output data 328 may reflect, for the corresponding customer, an expected change in the product volume in response to a modification to a customer-specific treatment offered by the organization for the provisioned product.

For example, executed elasticity engine 146 may access element 330A of perturbed output data 330 and element 328A of baseline output data 328 (each of which are associated with customer identifier 312), and may perform operations that compute a value 332 of the treatment elasticity with respect to the product provisioned for the customer associated with customer identifier 312 as a difference between the product value maintained in element 330A and the corresponding product value maintained in element 328A. In some instances, executed elasticity engine 146 may package customer identifier 312 and treatment elasticity value 332 into a corresponding, customer-specific element 334 of elasticity data 336, and executed elasticity engine 146 may perform any of the exemplary processes described herein to generate a value of the treatment elasticity with respect to the provisioned product for the customer of the organization associated with each additional, or alternate, customer identifier within customer data 302, and to package each of the additional, or alternate customer identifiers and the generated treatment elasticity value into a corresponding, customer-specific element of elasticity data 336.

Further, executed elasticity engine 146 may provide the elements of elasticity data 336 as input to classification engine 148, which upon execution by the one or more processors of computing system 130, may perform any of the exemplary processes described herein to assign an elasticity label characterizing the customers associated with corresponding ones of the customer identifiers and predicted treatment elasticity values as either a low-treatment-elasticity customer or a high-treatment-elasticity customer. As illustrated in FIG. 3B, executed classification engine 148 may access causal inferencing data store 151 and obtain elements of classifier composition data 160 and classifier parameter data 162. As described herein, classifier composition data 160 characterizes a composition of an input dataset for the trained classifier (e.g., including the customer-specific value of the treatment elasticity) and identifies each of the discrete data elements within the input data set, along with a sequence or position of these elements within the input data set, and classifier parameter data 162 includes the process parameters of the trained classifier.

In some instances, an input module 337 executed classification engine 148 may perform operations, consistent with classifier composition data 160, that generate one of input datasets 338 for each customer-specific element of elasticity data 336 based on corresponding, customer-ones of the consolidated data records maintained within consolidated data store 136. For example, as illustrated in FIG. 3A, executed input module 337 may access customer-specific element 334 of elasticity data 336, and may obtain customer identifier 312 and treatment elasticity value 332. Executed input module 337 may also access subset 314 of the consolidated data records that include, or reference, customer identifier 312, and based on treatment elasticity value 332 and on the elements of consolidated and aggregated data maintained within the consolidated data records of subset 314, executed input module 337 may generate a corresponding one of input datasets 338, such as input dataset 338A, associated with customer identifier 312 and having a structure and composition consistent with classifier composition data 160. Further, executed classification engine 148 may perform any of these exemplary processes to generate a corresponding one of input datasets 338 for each additional, or alternate, customer-specific element of elasticity data 336.

Executed input module 337 may provision input datasets 338, including input dataset 338A associated with customer identifier 312 and including treatment elasticity value 332, as input to an inferencing module 339 of executed classification engine 148. Executed inferencing module 339 may, for example, perform operations that apply the trained classifier to each of input datasets 338 in accordance with the process parameter values specified within classifier parameter data 162, and based on the application of the trained classifier to each of input datasets 338, executed inferencing module 339 may generate elements of customer-specific output data 340 that label corresponding ones of the customers as low-treatment-elasticity customers or high-treatment-elasticity customers. For example, as described herein, the trained classifier may include a trained, gradient-boosted, decision-tree process (e.g., the XGBoost process), and executed inferencing module 339 may perform operations, with the process parameter values specified within classifier parameter data 162, that that establish a plurality of nodes and a plurality of decision trees for the trained, gradient-boosted, decision-tree process, with may ingest and process each of input datasets 338 and generate a corresponding element of customer-specific output data 340. The elements of customer-specific output data 340 may include an alphanumeric character string that labels the corresponding ones of the customers as low-treatment-elasticity customers or high-treatment-elasticity customers (e.g., “HIGH” or “LOW,” etc.) or alternatively, may include numerical values that label the corresponding ones of the customers as low-treatment-elasticity customers or high-treatment-elasticity customers (e.g., a value of zero for low-treatment-elasticity customers and a value of unity for high-treatment-elasticity customers).

For example, as illustrated in FIG. 3B, element 340A of customer-specific output data 340 may include the alphanumeric character string “HIGH,” which labels the customer associated with customer identifier 312 as a high-treatment-elasticity customer. In some instances, executed classification engine 148 may package customer identifier 312, treatment elasticity value 332, which specifies the numerical value of the treatment elasticity value of the customer associated with customer identifier 312, and element 340A of customer-specific output data 340, which labels that customer as a high-treatment-elasticity customer, into a corresponding element 342 of classification data 170. Executed classification engine 148 may also perform any of the exemplary processes described herein to generate an additional element of classification data 170, including a corresponding one of the treatment elasticity values and the elements of output data 340, for each additional, or alternate, one of the customer identifiers maintained within customer data 302.

In some instances, executed classification engine 148 may store the elements of classification data within data repository 132, e.g., within a portion of causal inferencing data store 151. Additionally, in some instances (not illustrated in FIG. 3A), executed classification engine 148 may also cause computing system 130 to transmit all of, or a selected subset of, the elements of classification data 170 across network 120 to exception system 304, which may store the transmitted elements of classification data 170 within a locally accessible data repository.

As described herein, the organization may offer to provision one or more products to customers in accordance with product-specific, and in some instances, customer-specific rates. For example, and as described herein, the organization may operate a distributed computing system, and the organization may offer to provision computational resources (e.g., computational products), such as hours of processor time within a segment of the distributed computing cluster, in accordance with an established, per-unit rate (e.g., a per-unit price). Alternatively, and as described herein, the organization may correspond to a financial institution, which may offer to provision a financial product to their customers in accordance with an established, per-unit rate (e.g., a per-unit interest rate that includes a product- or customer-specific treatment above a key or benchmark interest rate). The established, per-unit rate may, for instance, reflect a standardized or benchmarked per-unit rate applied across broad segments of customers of the organization and across multiple temporal intervals, which may be characterized by varied levels of demand. In other instances, the established, per-unit rate may reflect a premium across the standardized or benchmarked per-unit rate, which may reflect changes in demand for the provisioned product or changes in market conditions.

By way of example, a device operable by a customer of the organization, or by a representative of the organization (e.g., an employee at a physical location of the organization), such as device 350, may transmit a request to computing system 130 to access one or more products available for provisioning to customers by the organization, such as, but not limited to, the computational and financial products described herein. Responsive to the received request, computing system 130 may generate, and transmit across network 120 to device 350, a response that offers to provision the request product to the customer in accordance with the established, per-unit rate. For example, the customer may request access to a certain volume of an available computational product during a specific temporal interval (e.g., 1,000 hours of processor time within a segment of the distributed computing cluster on during the specific temporal interval), and computing system 130 may response with an offer to provision the 1,000 hours of processor time within the segment of the distributed computing cluster at an established, per-unit rate of $0.07 per hour. Additionally, or alternatively, the customer may request access to a certain amount of an available financial products during a specific temporal interval, and computing system 130 may response with an offer to provision the available financial products to the customer established interest rate of 2.97%. The disclosed embodiments are, however, not limited to these exemplary products or established, per-unit rates, and in other instances, device 350 may request, and computing system 130 may offer to provision, any additional, or alternate, product in accordance with any additional, or alternate, per-unit rate appropriate the organization.

In some instances, the established per-unit rate offered for to the customer for the available product may be inconsistent with a per-unit rate previously offered to the customer by the organization, and based on the inconsistency, device 350 may generate and transmit an additional request, e.g., an exception request, that proposes a modification to the established per-unit rate offered for to the customer for the available product. By way of example, the per-unit rate of $0.07 per hour associated with the offer to provision the 1,000 of processor time within the segment of the distributed computing cluster may exceed a prior per-unit rate of $0.05 associated with provisioned processor time during prior temporal intervals, and device 350 may generate and transmit an exception request that requests an exception to the offered per-unit rate and propose a new, per-unit rate of $0.06 per hour of processor time. In other examples, the interest rate of 2.97% for the offered financial products may fall below an interest rate offered for similar financial products by the organization or by other organizations during a current or prior temporal intervals, and device 350 may generate and transmit an exception request that requests an exception to the offered interest rate and propose an increase of twenty-fine basis points in the offered interest rate, e.g., a modified interest rate of 3.22%. In some examples, computing system 130 may perform operations, described herein, that adjudicate (e.g., approve or deny) these requested exceptions to the per-unit rate offered for to the customer for the available product based on a customer-specific value of treatment elasticity with respect to the available product, which may be generated by computing system 130 using any of the exemplary, trained double machine-learning process described herein.

Referring to FIG. 3C, one or more application programs executed by client device 350, such as a mobile application associated with the organization, may generate and transmit an exception request 352 across network 120 to computing system 130. In some instances, exception request 352 may include a unique customer identifier of the customer associated with device 350 (e.g., customer identifier 312), a unique identifier 354 of device 350 (e.g., an IP address, a MAC address, an application cryptogram of the executed application program, etc.), a product identifier 356 that identifies uniquely the available product subject to the exception request (e.g., an alphanumeric product name or other identifier), and exception data 358 that characterizes the requested exception. By way of example, the elements of exception data 358 may include the initial, per-unit rate offered for to the customer for the available product and the proposed modification to the initial, per-unit rate requested by the customer.

In some instances, a programmatic interface established by computing system 130, such as API 308, may receive exception request 352 and may provide exception request 352 as an input to adjudication engine 150, which, upon execution by the one or more processor, may perform any of the exemplary processes described herein to adjudicate (e.g., to approve or deny) the requested exception to the initially offered per-unit rate based on the customer-specific value of treatment elasticity with respect to the available product and maintained within the elements of classification data 170. For example, executed adjudication engine 150 may obtain, from exception request 352, customer identifier 312 of the customer associated with device 350, and may access causal inferencing data store 151 and obtain the elements of classification data 170. Executed adjudication engine 150 may parse the elements of classification data 170 and determine that element 342 of classification data 170 includes customer identifier 312 and as such, includes the customer-specific value of treatment elasticity with respect to the available product associated with product identifier 356 (e.g., treatment elasticity value 332) and labelling data that labels the customer associated with customer identifier 312 as a high-treatment-elasticity customer (e.g., element 340A of customer-specific output data 340).

In some instances, executed adjudication engine 150 may also obtain, from one or more tangible, non-transitory memories of computing system 130, adjudication process data 360 that characterize one or more adjudication processes that, when implemented by executed adjudication engine 150, cause executed adjudication engine 150 to adjudicate the requested exception characterized by exception data 358 in accordance with the customer-specific value of treatment elasticity and additionally, or alternatively, the customer-specific elements of labelling data, e.g., that characterize the customer as a low-treatment-elasticity customer or a high-treatment elasticity customer. For example, for a customer labelled as a high-treatment elasticity customer, the one or more adjudication processes may cause executed adjudication engine 150 to approve the requested exception if the proposed modification to the initial, per-unit rate falls within a threshold percentage of the initially offered per-unit rate (e.g., 15% of the initially offered per-unit rate, etc.) or if a magnitude of the proposed modification to the initial, per-unit rate fails to exceed a threshold magnitude (e.g., $0.02 per hour of processor time, twenty-five basis points of an interest rate, etc.).

Further, for a customer labelled as a low-treatment elasticity customer, the one or more adjudication processes may cause executed adjudication engine 150 to deny any requested exception to the initially offered per-unit rate, or alternatively, to approve a predetermined fraction of the proposed modification to the initially offered, per-unit rate (e.g., to approve fifty percent or twenty-five percent of the requested modification, etc.) or to approve a reduction of the proposed modification the initially offered, per-unit rate of a predetermined magnitude (e.g., $0.01 per hour of processor time, ten basis points of an interest rate, etc.). The disclosed embodiments are, however, not limited to these exemplary adjudication processes, and in other instances, executed adjudication engine 150 may perform operations that adjudicate the requested exception characterized by exception data 358 in accordance with any additional, or alternate, adjudication rule, include based on the application of a trained, machine-learning or artificial intelligence process to an input dataset that characterizes the customer associated with customer identifier 312, the requested exception, or the available product.

By way of example, executed adjudication engine 150 may obtain element 340A of customer-specific output data 340 from element 342 of classification data 170, which labels the customer associated with customer identifier 312 as a high-treatment-elasticity customer, and executed adjudication engine 150 may perform any of the exemplary processes described herein to apply the one or more adjudication processes associated with high-treatment-elasticity customers to the elements of exception data 358 that characterizes the requested exception. As described herein, the elements of exception data 358 may include the initial, per-unit rate offered for to the customer for the available product and the proposed modification to the initial, per-unit rate requested by the customer. In some examples, based on the application of the one or more adjudication processes to the elements of exception data 358, executed adjudication engine 150 may elect to approve the proposed modification to the initial, per-unit rate, and executed adjudication engine 150 may generate elements of decision data 362 that confirm the approval of the requested exception and specify the now-approved modification to the initial, per-unit rate offered to the customer for the available product.

For example, as described herein, the proposed modification to the initially offered per-unit rate (e.g., $0.07 per hour of processor time) may reduce the per-hour cost of processor time by $0.01, which represents a reduction of 14.28%. As the proposed modification reduces the initially offered per-unit rate by less that the threshold percentage of the initially offered per-unit rate (e.g., the 15% threshold), executed adjudication engine 150 may approve the requested exception, and generate corresponding elements of decision data 362 that confirm the approval of the requested exception and specify the now-approved modification to the initial, per-unit rate offered to the customer for the available product, e.g., the approved, $0.06 per-hour cost for processing hours within the segment of the distributed computing cluster. Alternatively, and as described herein, the proposed modification to the initially offered per-unit rate may increase the initially offered interest rate for the financial products by twenty-five basis points. As the proposed modification include the initially offered per-unit rate by an amount equal to the threshold magnitude (e.g., the twenty-five basis points), executed adjudication engine 150 may approve the requested exception, and generate corresponding additional elements of decision data 362 that confirm the approval of the requested exception and specify the now-approved modification to the initial, interest rate offered to the customer for the available product, e.g., the approved, 3.22% interest rate.

Referring back to FIG. 3C, executed adjudication engine 150 may package customer identifier 312 and the elements of decision data 362 into corresponding portions of an exception response 364, and executed adjudication engine 150 may perform operations that cause computing system to transmit exception response 364 across network 120 to device 350. In some instances, the application program executed by device 350 may process exception response 364 and present a graphical representation of the elements of decision data 362, and the final decision on whether the rate exception has been granted for the available product, within a corresponding digital interface. By way of example, computing system 130 may perform any of the exemplary processes described herein to adjudicate the rate exception associated with exception request 352, and to transmit exception response 364 to device 350, in real-time and contemporaneously with generation of exception request 352 by the application program executed by device 350 (e.g., such as, but not limited to, within approximately thirty seconds of the generation of request 352 by the application executed by the device 350).

Further, in some instances, executed adjudication engine 150 may also provide decision data 362 as an input to a product allocation engine 366 executed by the one of more processors of computing system 130. In some instances, based on a decision to approve the requested exception, executed allocation engine 366 may perform operations that modify an allocation of the available product in accordance with the elements of decision data 362. For example, and as described herein, the elements of decision data 362 may indicate an approval of a rate exception to an initially offered per-unit rate for a computational resource, such as, but not limited to, the approved, $0.06 per-hour cost for processing hours within the segment of the distributed computing cluster operated by the organization. Based on the elements of decision data 362, executed produce allocation engine 366 may modify an allocation of computational resources within the distributed computing client to reflect the approved exception (e.g., the additional 1,000 hours of processor time within the segment of the distributed computing cluster), and may generate elements of allocation data 368 that reflect the modified allocation of computational resources to device 350 and/or the customer associated with customer identifier 312. Upon generation and storage of the elements of allocation data 368 within the one or more tangible memories of computing system 130, computing system 130 may grant device 350 and/or the customer associated with customer identifier 312 access to the computational resources of the distributed computing client in accordance with the modified allocation specified within allocation data 368.

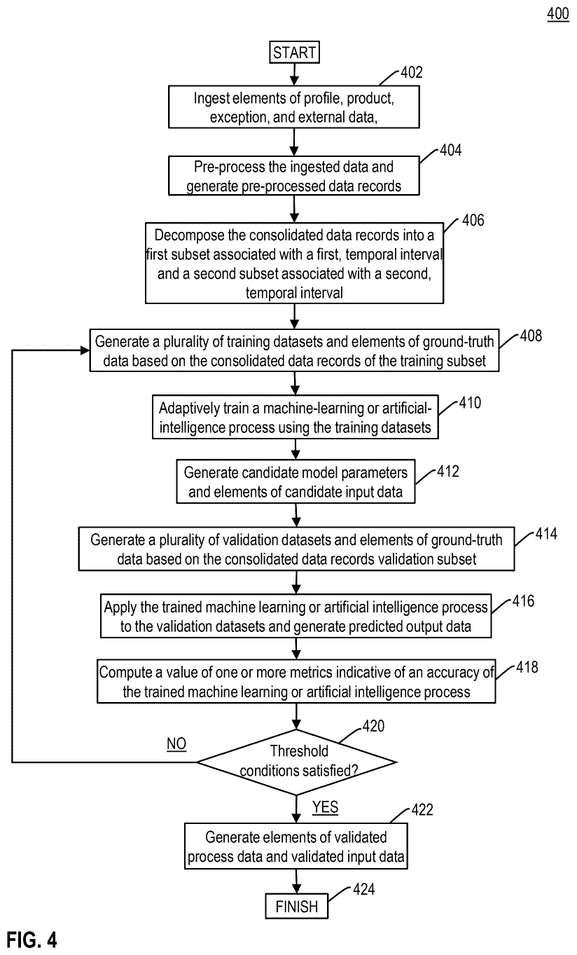

FIG. 4 is a flowchart of an exemplary process 400 for adaptively training a machine learning or artificial intelligence process, in accordance with some exemplary embodiments. In some instances, the machine learning or artificial intelligence process may include the de-noising process described herein, which may be trained adaptively to predict, at a temporal prediction point, a customer-specific value of a parameter of a provisioned product at a temporal endpoint of a future temporal interval using training and validation datasets extracted from temporally distinct subsets of preprocessed, consolidated, and aggregated data elements. Additionally, or alternatively, the machine learning or artificial intelligence process may include the de-biasing process described herein, which may be trained adaptively to predict, at the temporal prediction point, a customer-specific, per-unit rate offered by the organization for the product at the temporal endpoint of the future temporal interval using training and validation datasets extracted from temporally distinct subsets of the preprocessed, consolidated, and aggregated data elements. Further, in some instances, the machine learning or artificial intelligence process may also include the classifier described herein, which may be trained to label a customer of the organization as a low- or high-treatment-elasticity customer based on using corresponding training and validation datasets that include a customer-specific value of a treatment elasticity and feature values extracted from temporally distinct subsets of preprocessed, consolidated, and aggregated data elements.

As described herein, each of the de-biasing process, the de-noising process, and the classifier may include an ensemble or decision-tree process, such as a gradient-boosted decision-tree process (e.g., the XGBoost process), and the future temporal interval may include, but is not limited to a two-month interval. In some instances, one or more computing systems, such as, but not limited to, one or more of the distributed components of computing system 130, may perform one or of the steps of exemplary process 400 described herein.

Referring to FIG. 4, computing system 130 may perform any of the exemplary processes described herein to establish a secure, programmatic channel of communication with one or more additional computing systems, such as source systems 102A and 102B of FIG. 1, and to obtain, from the source computing systems, elements of profile, product, exception, and external data that identify and characterize one or more customers of the organization, interactions of these customers with the organization and with one or more products provisioned by the organization, and exceptions to initially offered rates associated with these customers (e.g., in step 402 of FIG. 4). Computing system 130 may also perform operations that store (or ingest) the obtained elements of profile, product, exception, and external data within one or more accessible data repositories, such as ingested data store 134 (e.g., also in step 402 of FIG. 4). In some instances, computing system 130 may perform the exemplary processes described herein to obtain and ingest the elements of profile, product, exception, and external data in accordance with a predetermined temporal schedule (e.g., on a monthly basis), or a continuous streaming basis, across the secure, programmatic channel of communication.

Further, computing system 130 may access the ingested elements of profile, product, exception, and external data, and may perform any of the exemplary processes described herein to pre-process the ingested elements of profile, product, exception, and external data, and generate one or more consolidated data records (e.g., in step 404 of FIG. 4). As described herein, the computing system 130 may store each of the consolidated data records within one or more accessible data repositories, such as consolidated data store 136 (e.g., also in step 404 of FIG. 4).

For example, and as described herein, each of the consolidated data records may be associated with a particular one of the customers and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of profile, product, exception, and external data that characterize the particular customer during the corresponding temporal interval associated with the temporal identifier, along one or more aggregated elements of profile, product, exception, and external data, such as, but not limited to, those described herein.

In some instances, computing system 130 may perform any of the exemplary processes described herein to decompose the consolidated data records into (i) a first subset of the consolidated data records having temporal identifiers associated with a first prior temporal interval (e.g., the training interval Δt_{training}, as described herein) and (ii) a second subset of the consolidated data records having temporal identifiers associated with a second prior temporal interval (e.g., the validation interval Δt_{validation}, as described herein), which may be separate, distinct, and disjoint from the first prior temporal interval (e.g., in step 406 of FIG. 4). By way of example, portions of the consolidated data records within the first subset may be appropriate to train the machine-leaning or artificial process (e.g., the gradient-boosted, decision-tree process described herein) during the training interval Δt_{training}, and portions of the consolidated records within the second subset may be appropriate to validating the trained, gradient-boosted, decision-tree process during the validation interval Δt_{validation}.

In some instances, computing system 130 may perform any of the exemplary processes described herein to generate a plurality of training datasets and corresponding elements of ground truth data based on elements of data obtained, extracted, or derived from all or a selected portion of the first subset of the consolidated data records (e.g., in step 408 of FIG. 4). By way of example, each of the plurality of training datasets may be associated with a corresponding one of the customers of the organization and a corresponding temporal interval, and may include, among other things a customer identifier associated with that corresponding customer and a temporal identifier representative of the corresponding temporal interval, as described herein. Further, and as described herein, each of the plurality of training datasets may also elements of data (e.g., feature values) that characterize the corresponding one of the customers, interactions of the corresponding customer with the organization and with one or more products provisioned by the organization, and exceptions to initially offered rates associated with these customers during a temporal interval disposed prior to the corresponding temporal interval, e.g., during the extraction interval Δt_{extract} described herein.

Based on the plurality of training datasets and the corresponding elements of ground-truth data, computing system 130 may also perform any of the exemplary processes described herein to train the machine-learning or artificial-intelligence process, e.g., the gradient-boosted decision-tree process described herein (e.g., in step 410 of FIG. 4). For example, and as described herein, computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that train the gradient-boosted, decision-tree process against the elements of training data included within each of the plurality of the training datasets.

In some examples, the distributed components of computing system 130 may perform any of the exemplary processes described herein in parallel to establish the plurality of nodes and a plurality of decision trees for the gradient-boosted, decision-tree process, and to train the gradient-boosted, decision-tree process against the elements of training data included within each of the plurality of the training datasets. The parallel implementation of these exemplary training processes by the distributed components of computing system 130 may, in some instances, be based on an implementation, across the distributed components, of one or more of the parallelized, fault-tolerant distributed computing and analytical protocols described herein.

Through the performance of these training processes, computing system 130 may compute one or more candidate process parameters that characterize the trained machine-learning or artificial-intelligence process, such as, but not limited to, candidate process parameters for the trained, gradient-boosted, decision-tree process described herein, such as, but not limited to, the exemplary process parameters described herein (e.g., in step 412 of FIG. 4). Further, and based on the performance of these training processes, computing system 130 may perform any of the exemplary processes described herein to generate candidate input data, which specifies a candidate composition of an input dataset for the trained machine-learning or artificial intelligence process, such as the trained, gradient-boosted, decision-tree process described herein (e.g., also in step 412 of FIG. 4).

Further, computing system 130 may perform any of the exemplary processes described herein to access the second subset of the consolidated data records, and to generate a plurality of validation subsets having compositions consistent with the candidate input data and to generate corresponding elements of ground-truth data (e.g., in step 414 of FIG. 4). As described herein, each of the plurality of the validation datasets may be associated with a corresponding one of the customers of the organization, and with a corresponding temporal interval within the validation interval Δt_{validation}, and may include a customer identifier associated with the corresponding one of the customers and a temporal identifier that identifies the corresponding temporal interval. Further, each of the plurality of the validation datasets may also include one or more feature values consistent with the candidate input data, associated with the corresponding one of the customers, and obtained, extracted, or derived from corresponding ones of the accessed second subset of the consolidated data records (e.g., during the corresponding extraction interval Δt_{extract}, as described herein).

In some instances, computing system 130 may perform any of the exemplary processes described herein to apply the trained machine-learning or artificial intelligence process (e.g., the trained, gradient-boosted, decision-tree process described herein) to respective ones of the validation datasets, and to generate corresponding elements of output data based on the application of the trained machine-learning or artificial intelligence process to the respective ones of the validation datasets (e.g., in step 416 of FIG. 4). As described herein, each of the generated elements of output data may be associated with a corresponding one of the validation datasets and as such, a corresponding one of the customers.

Further, and as described herein, the distributed components of computing system 130 may perform any of the exemplary processes described herein in parallel to validate the trained, gradient-boosted, decision-tree process described herein based on the application of the trained, gradient-boosted, decision-tree process (e.g., configured in accordance with the candidate process parameters) to each of the validation datasets. The parallel implementation of these exemplary validation processes by computing system 130 may, in some instances, be based on an implementation, across the distributed components, of one or more of the parallelized, fault-tolerant distributed computing and analytical protocols described herein.

In some examples, based on a comparison between corresponding elements of ground-truth data and validation output, computing system 130 may perform any of the exemplary processes described herein to compute a value of one or more metrics that characterize a predictive capability, and an accuracy, of the trained machine-learning or artificial intelligence process (such as the trained, gradient-boosted, decision-tree process described herein) based on the generated elements of output data and corresponding ones of the validation datasets (e.g., in step 418 of FIG. 4), and to determine whether all, or a selected portion of, the computed metric values satisfy one or more threshold conditions for a deployment of the trained machine-learning or artificial intelligence process (e.g., in step 420 of FIG. 4). As described herein, and for the trained, gradient-boosted, decision-tree process, the computed metrics may include, but are not limited to, one or more recall-based values (e.g., “recall@5,” “recall@10,” “recall@20,” etc.), one or more precision-based values for the trained, gradient-boosted, decision-tree process, and additionally, or alternatively, a computed value of an area under curve (AUC) for a precision-recall (PR) curve or a computed value of an AUC for a receiver operating characteristic (ROC) curve associated with the trained, gradient-boosted, decision-tree process.

Further, and as described herein, the threshold requirements for the trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the trained, gradient-boosted, decision-tree process satisfies the one or more threshold requirements for deployment.

If, for example, computing system 130 were to establish that one, or more, of the computed metric values fail to satisfy at least one of the threshold requirements (e.g., step 420; NO), computing system 130 may establish that the trained machine-learning or artificial intelligence process (e.g., the trained, gradient-boosted, decision-tree process) is insufficiently accurate for deployment and a real-time application to the elements of profile, product, exception, and external data described herein. Exemplary process 400 may, for example, pass back to step 410, and computing system 130 may perform any of the exemplary processes described herein to generate additional training datasets based on the elements of the consolidated data records maintained within the first subset.

Alternatively, if computing system 130 were to establish that each computed metric value satisfies threshold requirements (e.g., step 420; YES), computing system 130 may deem the trained machine-learning or artificial intelligence process (e.g., the trained gradient-boosted, decision-tree process described herein) ready for deployment and real-time application to the elements of profile, product, account, and external data described herein, and may perform any of the exemplary processes described herein to generate process parameter data that includes the candidate process parameters, and process input data that includes the candidate input data, associated with the of the trained machine-learning or artificial intelligence process (e.g., in step 422 of FIG. 4). Exemplary process 400 is then complete in step 426.

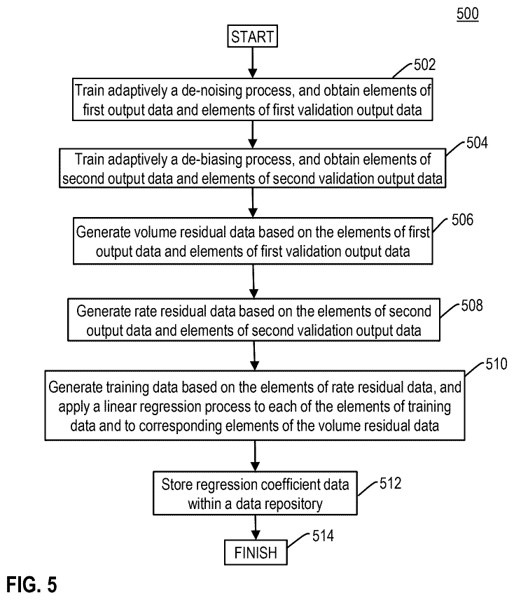

FIG. 5 is a flowchart of an exemplary process 500 for training adaptively a double machine-learning process to estimate values of treatment elasticity within a distributed computing environment, in accordance with some examples. For example, and as described herein, the estimated value of the treatment elasticity may, for a particular customer of the organization, characterize an expected change in a value of a parameter of a product provisioned to the customer in response to a modification to a rate, such as the per-unit rate, offered by the organization for the provisioned product. In some instances, one or more computing systems, such as, but not limited to, one or more of the distributed components of computing system 130, may perform one or of the steps of exemplary process 500 described herein.

Referring to FIG. 5, computing system 130 may perform any of the exemplary processes described herein to train adaptively a de-noising process to predict, at a temporal prediction point, a parameter of a provisioned product (e.g., the product volume described herein) at a temporal endpoint of a future temporal interval (e.g., in step 502 of FIG. 5), and to train adaptively a de-biasing process to predict, at the temporal prediction point, a treatment offered by the organization, and associated with the consumption, use, or holding of the product volume, at the temporal endpoint of a future temporal interval (e.g., in step 504 of FIG. 5). As described herein, the de-noising process and the de-biasing process each correspond to an ensemble or decision-tree process, such as a gradient-boosted decision-tree process (e.g., the XGBoost process), and the future temporal interval may correspond to a two-month interval, e.g., the temporal endpoint is disposed two-months subsequent to the temporal prediction point.

In some instances, through the adaptive training of the de-noising and the de-biasing processes, computing system 130 may perform any of the exemplary processes described herein to generate, or obtain, elements of first ground-truth data and first validation output data associated with the adaptive training of the de-noising process (e.g., also in step 502 of FIG. 5), and to generate, or obtain, elements of second ground-truth data and second validation output data associated with the adaptive training of the de-biasing process (e.g., also in step 504 of FIG. 5). For example, and as described herein, each element of the first validation output data may include a customer identifier (e.g., identifying a corresponding customer of the organization), a temporal identifier (e.g., identifying a corresponding temporal prediction point), and a predicted value of a product volume associated with the corresponding customer at the temporal endpoint t_{pred} of the target, future temporal interval Δt_{target}, e.g., a date two-months subsequent to the corresponding temporal prediction point. Further, as described herein, each element of the first ground-truth data 251 may be associated with a corresponding element of the first validation output data (and as such, with the corresponding customer and the corresponding temporal prediction point), and each of the elements of the first ground-truth data may specify the actual value of a product volume used, consumed, or held by corresponding customer at the temporal endpoint t_{pred} of the target, future temporal interval Δt_{target}.

Further, and as described herein, each element of the second validation output data may include, among other things, the customer identifier (e.g., identifying the corresponding customer of the organization), the temporal identifier (e.g., identifying the corresponding temporal prediction point), and a predicted value of a treatment offered by the organization to the corresponding customer for the provisioned product at the temporal endpoint t_{pred} of the target, future temporal interval Δt_{target}, e.g., the date two-months subsequent to the corresponding temporal prediction point. Further, as described herein, each element of the second ground-truth data may be associated with a corresponding element of the second validation output data (and as such, with the corresponding customer and the corresponding temporal prediction point), and each of the elements of the second ground-truth data may specify the actual rate (or the actual rate treatment) offered by the organization to the corresponding customer for the provisioned product at the temporal endpoint t_{pred} of the target, future temporal interval Δt_{target}.

Referring back to FIG. 5, computing system 130 may perform any of the exemplary processes described herein to compute, for each element of the first ground-truth data and the first validation output data, a value of a volume residual for the corresponding element based on a difference between the actual value of the value of the product volume (e.g., maintained within the element of the first ground-truth data) and the predicted value of product volume, which may be maintained within the element of the first validation output data (e.g., in step 506 of FIG. 5). As described herein, computing system 130 may perform operations that package the volume residual value into an element of volume residual data, along with the customer identifier of the corresponding customer and the corresponding temporal identifier maintained within the first validation output data, and computing system 130 may perform any of the exemplary processes described herein to generate an additional element of the volume residual data associated with each additional, or alternate, pair of elements of the first ground-truth data and the first validation output data (e.g., also in step 506 of FIG. 5).

Computing system 130 may also perform any of the exemplary processes described herein to compute, for each element of the second ground-truth data and the second validation output data, a value of a treatment residual for the corresponding element based on a difference between the actual value of the value of the rate (e.g., maintained within the element of the second ground-truth data) and the predicted treatment, which may be maintained within the element of the second validation output data (e.g., in step 508 of FIG. 5). As described herein, computing system 130 may perform operations that package the treatment residual value into an element of treatment residual data, along with the customer identifier of the corresponding customer and the corresponding temporal identifier maintained within the second validation output data, and computing system 130 may perform any of the exemplary processes described herein to generate an additional element of the treatment residual data associated with each additional, or alternate, pair of elements of the second ground-truth data and the second validation output data (e.g., also in step 508 of FIG. 5).

Computing system 130 may also perform any of the exemplary processes described herein to generate elements of training data based on the customer-specific elements of the treatment residual data and on feature values obtain from corresponding validation sets generated through the adaptive training of the de-noising and/or de-biasing processes (e.g., in step 510 of FIG. 5). Further, in step 510, computing system 130 may perform any of the exemplary processes described herein to apply a linear regression process to each of the elements of training data and to corresponding elements of the volume residual data, and to generate elements of regression coefficient data 268 that specifies a linear relationship between (i) the customer-specific values of the volume residuals and (ii) the customer-specific values of treatment residual and the customer-specific feature values (e.g., also in step 510 of FIG. 5). The regression process may, for example, include a multiple linear regression process or an ordinary least squares (OLS) regression process, and based on the application of the linear regression process to each of the elements of training data, computing system 130 may generate elements of coefficient data, which may include a value of an intercept and regression coefficients for each of the independent variables described herein, and computing system 130 may store the elements of coefficient data within a corresponding portion of the one or more tangible, non-transitory memories, e.g., as elasticity process parameters 164 within causal inferencing data store 151 (e.g., in step 512 of FIG. 5). Exemplary process 500 is then complete in step 514.

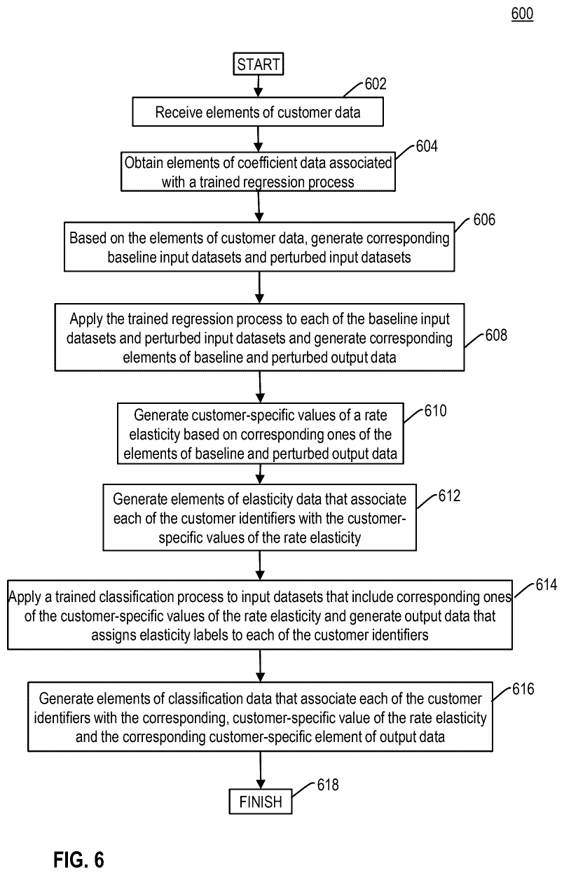

FIG. 6 is an exemplary process for estimating values of treatment elasticity using trained double machine-learning processes and labelling the determined values of treatment elasticity using trained, classifiers, according to some examples. For in, and as described herein, the estimated value of the treatment elasticity may, for a particular customer of the organization, characterize an expected change in a value of a parameter of a product provisioned to the customer, such as a product volume, in response to a modification to a rate, such as the per-unit rate, offered by the organization for the provisioned product. In some instances, one or more computing systems, such as, but not limited to, one or more of the distributed components of computing system 130, may perform one or of the steps of exemplary process 600 described herein.

Referring to FIG. 6, computing system 130 may perform any of the exemplary processes described herein to receive elements of customer data, which includes a unique, customer identifier (e.g., the alphanumeric character string described herein) for all, or a selected subset, of customers of the organization subject to classification labelling (e.g., in step 602). Computing system 130 may obtain, from the one or more tangible, non-transitory memories (e.g., from causal inferencing data store 151 of FIG. 1), elements of coefficient data that specify each of the independent variables associated with the trained regression process, and examples of these independent variables include, but are not limited to, a treatment offered by the organization for the provisioned product and all, or a subset, of the feature values included within validation datasets 250, which characterize corresponding customers of the organization, interactions of these customers with the organization and/or products provisioned by the organization, and/or exceptions to initially offered rates associated with these customers (e.g., in step 604 of FIG. 6).

Computing system 130 may also perform any of the exemplary processes described herein to generate, for each of the customer identifiers, a corresponding baseline input dataset and a corresponding perturbed input dataset, each of which have compositions consistent with the coefficient data (e.g., in step 606 of FIG. 6). In some instances, and as described herein, each of the baseline input datasets may include a baseline treatment, which may correspond to an average rate offered by the organization for the provisioned product during one or more prior temporal intervals and additionally, or alternatively, an average rate treatment offered by the organization for the provisioned product during the one or more prior temporal intervals. Further, each of the perturbed input datasets may include a perturbed treatment, which may reflect a modification of a predetermined magnitude to the baseline treatment, such as, but not limited to a percentage increase or decrease in the baseline treatment (e.g., 5%, 10%, etc.) or an increase or decrease of a predetermined number of basis points (e.g., ten basis points, twenty, basis points, etc.).

In some instances, computing system 130 may also perform any of the exemplary processes described herein to: (i) apply the trained regression process to each of the baseline input datasets in accordance with the coefficients and intercept set forth in coefficient data, and to generate a corresponding element of baseline output data (e.g., in step 608 of FIG. 6); and (ii) apply the trained regression process to each of the perturbed input datasets in accordance with the coefficients and intercept set forth in coefficient data, and to generate a corresponding element of perturbed output data (e.g., also in step 608 of FIG. 6) Computing system 130 may also determine, for each of the customer identifiers maintained within the elements of customer data, a value of a customer-specific, treatment elasticity with respect to a product provisioned by the organization based on a computed difference between the corresponding elements of the perturbed output data and baseline output data (e.g., in step 610 of FIG. 6), and may generate elements of elasticity data that associate each of the customer identifiers with the customer-specific values of the treatment elasticity (e.g., also in step 612 of FIG. 6).

Executed computing system 130 may also perform any of the exemplary processes described herein to assign an elasticity label characterizing the customers associated with corresponding ones of the customer identifiers and predicted treatment elasticity values as either a low-treatment-elasticity customer or a high-treatment-elasticity customer (e.g., in step 614 of FIG. 6). For example, and as described herein, computing system 130 may obtain elements of classifier composition data that characterizes a composition of an input dataset for the trained classifier (e.g., including the customer-specific value of the treatment elasticity) and elements of classifier parameter data includes the process parameters of the trained classifier (e.g., also in step 614 of FIG. 6).

In some instances, computing system 130 may perform operations, consistent with the elements of classifier composition data, that generate an additional input dataset for each customer-specific element of elasticity data based on corresponding, customer-ones of the consolidated data records maintained within consolidated data store 136, and computing system 130 may perform operations that apply the trained classifier to each of the additional input datasets in accordance with the process parameter values specified within the classifier parameter data (e.g., also in step 614 of FIG. 6). Based on the application of the trained classifier to each of the input datasets, computing system 130 may perform operations, described herein, that generate elements of customer-specific output data that label corresponding ones of the customers as low-treatment-elasticity customers or high-treatment-elasticity customers (e.g., also in step 614 of FIG. 6).

Further, in some instances, computing system 130 may generate, and store within a data repository, elements of classification data that, for each of the customers, include the corresponding customer identifier, the corresponding, customer-specific value of the treatment elasticity, and the corresponding, customer-specific element of output data, which labels the corresponding customer as a low-treatment-elasticity customer or a high-treatment-elasticity customer (e.g., in step 616 of FIG. 6). Exemplary process 600 is then complete in step 618.

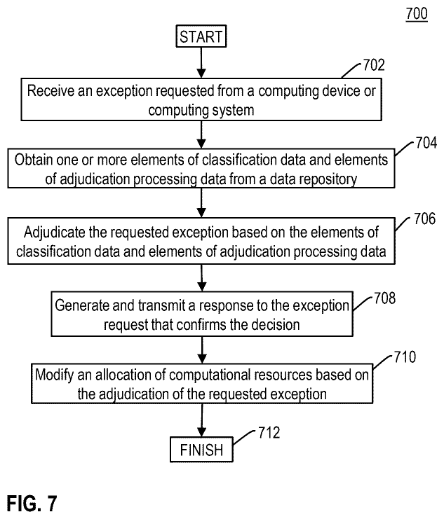

FIG. 7 is a flowchart of an exemplary process for adjudicating exception requests using trained double machine-learning processes, in accordance with some examples. As described herein, an exception request may correspond to a request, by a corresponding one of the customers, to obtain an exception to a rate offered initially for a particular product provisioned by the organization, such as, but not limited to, the computational resources and financial products described herein. In some instances, one or more computing systems, such as, but not limited to, one or more of the distributed components of computing system 130, may perform one or of the steps of exemplary process 700 described herein.

Referring to FIG. 7, computing system 130 may receive an exception requested from a computing device or computing system associated with a customer of the organization or with a representative of the organization (e.g., in step 702 of FIG. 7). As described herein, the received exception request may include a unique customer identifier of the customer associated with the computing system or device (e.g., customer identifier 312), a unique identifier of the computing system or device (e.g., an IP address, a MAC address, an application cryptogram of an executed application program, etc.), a product identifier that identifies uniquely the available product subject to the exception request (e.g., an alphanumeric product name or other identifier), and exception data that characterizes the requested exception. By way of example, the elements of exception data may include the initial, per-unit rate offered for to the customer for the available product and the proposed modification to the initial, per-unit rate requested by the customer.

Computing system 130 may obtain one or more elements of classification data and elements of adjudication processing data from corresponding portions of an accessible data repository (e.g., in step 704 of FIG. 7) As described herein, each of the elements of classification data may associated a corresponding customer identifier with a corresponding, customer-specific value of the treatment elasticity, and a corresponding, customer-specific element of output data, which labels a customer associated with the customer identifier as a low-treatment-elasticity customer or a high-treatment-elasticity customer. Further, and as described herein, the elements of adjudication process data may characterize one or more adjudication processes that, when implemented by computing system 130, cause computing system 130 to adjudicate the requested exception characterized by the exception data in accordance with the customer-specific value of treatment elasticity and additionally, or alternatively, the customer-specific elements of labelling data, e.g., that characterize the customer as a low-treatment-elasticity customer or a high-treatment elasticity customer.

In some instances, computing system 130 may perform any of the exemplary processes described herein to adjudicate (e.g., to approve or deny) the requested exception to the initially offered per-unit rate in accordance with the one or more adjudication processes and based on the customer-specific value of treatment elasticity with respect to the available product and the corresponding elements of labelling data maintained within the classification data (e.g., in step 706 of FIG. 7). Computing system 130 may also perform operations that generate, and transmit to the computing device or system, a response to the exception requests that confirms the decision to deny, or alternatively, approve the requested exception (e.g., in step 708 of FIG. 7). Further, in response to a decision approving the requested exception, or alternatively, denying the requested exception, computing system 130 may perform any of the exemplary processes described herein to modify an allocation of an available product, such as an allocation of computational resources within the distributed computing client to reflect the approved or denied exception, and computing system 130 may generate elements of allocation data that reflect the modified allocation of computational resources to computing system or service that initiated the exception request (e.g., in step 710 of FIG. 7). Exemplary process 700 is then complete in step 710.

### D. Exemplary Computing Architectures

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Exemplary embodiments of the subject matter described in this specification, including, but not limited to, training engine 142, elasticity engine 146, classification engine 148, adjudication engine 150, application programming interfaces (APIs) 206 and 308, ingestion engine 208, pre-processing engine 212, training input module 238, adaptive training and validation module 244, residual engine 248, regression module 266, input module 323, regression module 325, input module 337, inferencing module 339, and allocation engine 366, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
receive a request from a device via the communications interface, the request comprising an identifier associated with the device and exception data, and the exception data comprising a requested modification to a value of a parameter of a data exchange;
obtain labelling data based on an application of a trained classifier to a first input dataset that includes a value of an elasticity parameter associated with the request;
generate elements of decision data associated with the requested modification based on the labelling data and on the exception data; and
transmit, to the device via the communications interface, a response to the request that includes the elements of decision data.

2. The apparatus of claim 1, wherein the trained classifier comprises a trained, gradient-boosted, decision-tree process.

3. The apparatus of claim 1, wherein the at least one processor is further configured to determine the value of the elasticity parameter based on an application of a trained, double-machine-learning process to a second input dataset that includes at least the parameter value.

4. The apparatus of claim 3, wherein the at least one processor is further configured to execute the instructions to:
obtain, from the memory, elements of composition data associated with the trained, double-machine-learning process and a value of a process parameter of the trained, double-machine-learning process;
perform operations that generate the second input dataset based on the parameter value and at least one additional parameter value associated with the identifier; and
apply the trained, double-machine-learning process to the second input dataset in accordance with the one or more process parameter values.

5. The apparatus of claim 3, wherein the at least one processor is further configured to execute the instructions to:
obtain, from the memory, elements of classifier composition data associated with the trained classifier and a value of a classifier parameter of the trained classifier;
perform operations that generate the first input dataset based on the value of the elasticity parameter and at least one additional parameter value associated with the identifier; and
apply the trained classifier to the first input dataset in accordance with the classifier parameter value.

6. The apparatus of claim 1, wherein the at least one processor is further configured to execute the instructions to:
obtain elements of classification data from the memory, the elements of classification data being generated being generated based on the application of the trained classifier to the first input dataset; and
based on the identifier, obtain the labelling data from at least one of the elements of classification data.

7. The apparatus of claim 1, wherein the at least one processor is further configured to execute the instructions to:
obtain elements of adjudication process data that characterize an adjudication process; and
generate the elements of decision data based on an application of the adjudication process to the labelling data and the exception data.

8. The apparatus of claim 7, wherein:
the at least one processor is further configured to execute the instructions to perform operations that approve the requested modification to the parameter value of the based on the application of the adjudication process to the labelling data and the exception data; and
the elements of decision data confirm the approval of the requested modification.

9. The apparatus of claim 8, wherein the at least one processor is further configured to execute the instructions to:
modify an allocation of a computational resource to the device based on the approval of the requested modification;
generate allocation data indicative of the modified allocation of the computational resource and store the allocation data within a portion of the memory.

10. The apparatus of claim 8, wherein:
the at least one processor is further configured to execute the instructions to, based on the application of the adjudication process to the labelling data and the exception data, perform operations that decline the requested modification and generate an additional modification to the parameter value; and
the elements of decision data comprise the additional modification to the parameter value.

11. The apparatus of claim 1, wherein the device is configured to present at least a subset of the elements of the decision data within a digital interface.

12. A computer-implemented method, comprising:
receiving a request from a device using at least one processor, the request comprising an identifier associated with the device and exception data, and the exception data comprising a requested modification to a value of a parameter of a data exchange;
obtaining, using the at least one processor, labelling data based on an application of a trained classifier to a first input dataset that includes a value of an elasticity parameter associated with the request;
generating, using the at least one processor, elements of decision data associated with the requested modification based on the labelling data and on the exception data; and
transmitting, to the device using the at least one processor, a response to the request that includes the elements of decision data.

13. The computer-implemented method of claim 12, wherein the trained classifier comprises a trained, gradient-boosted, decision-tree process.

14. The computer-implemented method of claim 12, further comprising determining, using the at least one processor, the value of the elasticity parameter based on an application of a trained, double-machine-learning process to a second input dataset that includes at least the parameter value.

15. The computer-implemented method of claim 14, further comprising:
obtaining, from a data repository, and using the at least one processor, elements of composition data associated with the trained, double-machine-learning process and a value of a process parameter of the trained, double-machine-learning process;
performing operations, using the at least one processor, that generate the second input dataset based on the parameter value and at least one additional parameter value associated with the identifier; and
using the at least one processor, applying the trained, double-machine-learning process to the second input dataset in accordance with the one or more process parameter values.

16. The computer-implemented method of claim 14, further comprising:
obtaining, from a data repository, and using the at least one processor, elements of classifier composition data associated with the trained classifier and a value of a classifier parameter of the trained classifier;
performing operations, using the at least one processor, that generate the first input dataset based on the value of the elasticity parameter and at least one additional parameter value associated with the identifier; and
using the at least one processor, applying the trained classifier to the first input dataset in accordance with the classifier parameter value.

17. The computer-implemented method of claim 12, wherein:
the computer-implemented method further comprises obtaining, using the at least one processor, elements of classification data from a data repository, the elements of classification data being generated based on the application of the trained classifier to the first input dataset; and
based on the identifier, obtaining the labelling data from at least one of the elements of classification data using the at least one processor.

18. The computer-implemented method of claim 12, wherein the at least one processor is further configured to execute the instructions to:
obtain elements of adjudication process data that characterize an adjudication process; and
generate the elements of decision data based on an application of the adjudication process to the labelling data and the exception data.

19. The computer-implemented method of claim 18, wherein:
the computer-implemented method further comprises performing operations, using the at least one processor, that approve the requested modification to the parameter value of the data exchange based on the application of the adjudication process to the labelling data and the exception data; and
the elements of decision data confirm the approval of the requested modification.

20. A tangible, non-transitory computer-readable medium storing instructions that, when executed by at least one processor, cause the at least one processor to perform a method, comprising:
receiving a request from a device, the request comprising an identifier associated with the device and exception data, and the exception data comprising a requested modification to a value of a parameter of a data exchange;
obtaining labelling data based on an application of a trained classifier to a first input dataset that includes a value of an elasticity parameter associated with the request;
generating elements of decision data associated with the requested modification based on the labelling data and on the exception data; and
transmitting, to the device, a response to the request that includes the elements of decision data.
